(19) United States
(12) Patent Application Publication
(10) Pub. No.: US 2010/0036581 A1
(43) Pub. Date: Feb. 11, 2010

(54) Internal Combustion Engine Control Device

(75) Inventor: Kaoru Ohtsuka, Mishima-shi (JP)

Correspondence Address: OLIFF & BERRIDGE, PLC, P.O. BOX 320850, ALEXANDRIA, VA, 22320-4850, US

(73) Assignee: Toyota Jidosha Kabushiki Kaisha, Toyota-shi (JP)

(21) Appl. No.: 12/311,781

(22) PCT Filed: Jun. 27, 2008
(86) PCT No.: PCT/JP2008/061697

§ 371 Date: Apr. 13, 2009

(30) Foreign Application Priority Data
Aug. 10, 2007 (JP) 2007-209897

(51) Int. Cl. G06F 19/00

(52) U.S. Cl. 701/102

(57) ABSTRACT

Disclosed is an internal combustion engine control device capable of accurately achieving a target torque. At time t11, which precedes an exhaust stroke, a target throttle angle is calculated in accordance with the target torque. During a period between time t12 and time t13, the actual throttle angle is changed to match the target throttle angle calculated at time t11. At time t14 during a subsequent intake stroke, the target torque decreases. At time t18 during a subsequent compression stroke, a target ignition timing is calculated in accordance with the latest (decreased) target torque.

### TECHNICAL FIELD

The present invention relates to a control device for an internal combustion engine, and more particularly to achieving a target torque of an internal combustion engine.

### BACKGROUND ART

There is a known device (refer, for instance, to Patent Document 1) that divides a target torque value for an internal combustion engine into the target value to be achieved by controlling a throttle valve and the target value to be achieved by controlling, for instance, ignition timing and fuel injection amount.

### Patent Document 1: JP-A (PCT) No. 1999-509910

### DISCLOSURE OF THE INVENTION

### Problem to be Solved by the Invention

However, the device disclosed in Patent Document 1 simultaneously sets a throttle angle, ignition timing, and other controlled variables. Therefore, if the target torque changes after setup of the controlled variables due, for instance, to disturbance or variations in internal combustion engine component parts, the device may not accurately achieve the target torque.

Further, if the target torque decreases after the throttle valve is opened, the device may not accurately achieve the target torque.

The present invention has been made to solve the above problem. It is an object of the present invention to provide an internal combustion engine control device that is capable of accurately achieving a target torque.

### Means for Solving the Problem

To achieve the above mentioned purpose, the first aspect of the present invention is an internal combustion engine control device comprising:

target torque acquisition means for acquiring a target torque of an internal combustion engine;

torque estimation means for estimating the torque to be generated by the internal combustion engine;

first adjustment means capable of adjusting the torque to be generated by the internal combustion engine;

second adjustment means capable of adjusting, with a higher response than the first adjustment means, the torque to be generated by the internal combustion engine; and

controlled variable setup means, which sets a controlled variable for the first adjustment means in accordance with a target torque at a first timing, and sets a controlled variable for the second adjustment means in accordance with a target torque at a second timing, which comes after the first timing, and with a torque estimated at the second timing,

wherein the interval between the first timing and the second timing is not longer than one combustion cycle of the internal combustion engine.

The second aspect of the present invention is an internal combustion engine control device comprising:

target torque acquisition means for acquiring a target torque of an internal combustion engine;

first adjustment means capable of adjusting the torque to be generated by the internal combustion engine;

second adjustment means capable of adjusting, with a higher response than the first adjustment means, the torque to be generated by the internal combustion engine; and

controlled variable setup means, which sets a controlled variable for the first adjustment means in accordance with a target torque at a first timing, and sets a controlled variable for the second adjustment means in accordance with a target torque at a second timing, which comes after the first timing,

wherein the interval between the first timing and the second timing is not longer than one combustion cycle of the internal combustion engine.

The third aspect of the present invention is an internal combustion engine control device comprising:

target torque acquisition means for acquiring a target torque of an internal combustion engine;

torque estimation means for estimating the torque to be generated by the internal combustion engine;

first adjustment means capable of adjusting the torque to be generated by the internal combustion engine;

second adjustment means capable of adjusting, with a higher response than the first adjustment means, the torque to be generated by the internal combustion engine; and

controlled variable setup means, which sets a controlled variable for the first adjustment means in accordance with a target torque at a first timing, and sets a controlled variable for the second adjustment means in accordance with a torque estimated at a second timing, which comes after the first timing,

wherein the interval between the first timing and the second timing is not longer than one combustion cycle of the internal combustion engine.

The fourth aspect of the present invention is the internal combustion engine control device according to any one of the first to third aspects of the present invention,

wherein the controlled variable setup means further sets a controlled variable for the second adjustment means in accordance with a target torque at a third timing, which comes after the second timing, and with a torque estimated at the third timing, and

wherein the interval between the first timing and the third timing is not longer than one combustion cycle of the internal combustion engine.

The fifth aspect of the present invention is the internal combustion engine control device according to any one of the first to third aspects of the present invention,

wherein the controlled variable setup means further sets a controlled variable for the second adjustment means in accordance with a target torque at a third timing, which comes after the second timing, and

wherein the interval between the first timing and the third timing is not longer than one combustion cycle of the internal combustion engine.

The sixth aspect of the present invention is the internal combustion engine control device according to any one of the first to third aspects of the present invention,

wherein the controlled variable setup means further sets a controlled variable for the second adjustment means in accordance with a torque estimated at a third timing, which comes after the second timing, and

wherein the interval between the first timing and the third timing is not longer than one combustion cycle of the internal combustion engine.

The seventh aspect of the present invention is the internal combustion engine control device according to any one of the first to sixth aspects of the present invention, the internal combustion engine having a lean-burn capability, further comprising operation mode judgment means for judging an operation mode of the internal combustion engine,

wherein the controlled variable setup means sets a controlled variable for the second adjustment means in consideration of the operation mode.

The eighth aspect of the present invention is the internal combustion engine control device according to any one of the first to sixth aspects of the present invention,

wherein the second adjustment means includes fuel injection means and ignition means, and

wherein the controlled variable setup means preferentially sets a controlled variable for the ignition means at the second or third timing when the air-fuel ratio becomes lower than a predetermined value due to a controlled variable that is set for the fuel injection means at the second or third timing.

The ninth aspect of the present invention is the internal combustion engine control device according to the eighth aspect of the present invention,

wherein the controlled variable setup means includes judgment means for judging whether a controlled variable for the second adjustment means is attainable, and when the controlled variable for the ignition means is judged by the judgment means to be unattainable, sets a controlled variable for the fuel injection means at the second or third timing even when the controlled variable for the ignition means is to be preferentially set.

The tenth aspect of the present invention is the internal combustion engine control device according to any one of the first to sixth aspects of the present invention,

wherein the second adjustment means includes fuel injection means and an exhaust variable valve mechanism that is capable of changing the valve opening characteristics of an exhaust valve, and

wherein the controlled variable setup means preferentially sets a controlled variable for the exhaust variable valve mechanism at the second or third timing when the air-fuel ratio becomes lower than a predetermined value due to a controlled variable that is set for the fuel injection means at the second or third timing.

The eleventh aspect of the present invention is the internal combustion engine control device according to the tenth aspect of the present invention,

wherein the controlled variable setup means includes judgment means for judging whether a controlled variable for the second adjustment means is attainable, and when the controlled variable for the exhaust variable valve mechanism is judged by the judgment means to be unattainable, sets a controlled variable for the fuel injection means at the second or third timing even when the controlled variable for the exhaust variable valve mechanism is to be preferentially set.

The twelfth aspect of the present invention is the internal combustion engine control device according to any one of the first to sixth aspects of the present invention,

wherein the second adjustment means includes ignition means and an intake variable valve mechanism that is capable of changing the valve opening characteristics of an intake valve, and

wherein the controlled variable setup means preferentially sets a controlled variable for the ignition means at the second or third timing.

The thirteenth aspect of the present invention is the internal combustion engine control device according to the twelfth aspect of the present invention,

wherein the controlled variable setup means includes judgment means for judging whether a controlled variable for the second adjustment means is attainable, and when the controlled variable for the ignition means is judged by the judgment means to be unattainable, sets a controlled variable for the intake variable valve mechanism at the second or third timing even when the controlled variable for the ignition means is to be preferentially set.

### Advantages of the Invention

According to the first aspect of the present invention, the controlled variable for the second adjustment means, which exhibits a higher torque response than the first adjustment means, is set at the second timing after the controlled variable for the first adjustment means is set at the first timing. The interval between the first timing and the second timing is not longer than one combustion cycle of the internal combustion engine. Therefore, the target torque can be achieved by the controlled variable for the second adjustment means even if the target torque changes during one combustion cycle after the controlled variable for the first adjustment means is set. In addition, the target torque can be accurately achieved because the controlled variable for the second adjustment means is set in accordance with the target torque for the second timing and the torque estimated at the second timing.

According to the second aspect of the present invention, the controlled variable for the second adjustment means, which exhibits a higher torque response than the first adjustment means, is set at the second timing after the controlled variable for the first adjustment means is set at the first timing. The interval between the first timing and the second timing is not longer than one combustion cycle of the internal combustion engine. Therefore, the target torque can be achieved by the controlled variable for the second adjustment means even if the target torque changes during one combustion cycle after the controlled variable for the first adjustment means is set. In addition, the target torque can be accurately achieved because the controlled variable for the second adjustment means is set in accordance with the target torque for the second timing.

According to the third aspect of the present invention, the controlled variable for the second adjustment means, which exhibits a higher torque response than the first adjustment means, is set at the second timing after the controlled variable for the first adjustment means is set at the first timing. The interval between the first timing and the second timing is not longer than one combustion cycle of the internal combustion engine. Therefore, the target torque can be achieved by the controlled variable for the second adjustment means even if the target torque changes during one combustion cycle after the controlled variable for the first adjustment means is set. In addition, the target torque can be accurately achieved because the controlled variable for the second adjustment means is set in accordance with the torque estimated at the second timing.

According to the fourth aspect of the present invention, the controlled variable for the second adjustment means is further set at the third timing after the controlled variable for the second adjustment means is set at the second timing. The interval between the first timing and the third timing is not longer than one combustion cycle of the internal combustion engine. Therefore, the target torque can be achieved by the controlled variable for the second adjustment means, which is set at the second or third timing, even if the target torque changes during one combustion cycle after the controlled variable for the first adjustment means is set. In addition, the target torque can be accurately achieved because the controlled variable for the second adjustment means is set in accordance with the target torque for the third timing and the torque estimated at the third timing.

According to the fifth aspect of the present invention, the controlled variable for the second adjustment means is further set at the third timing after the controlled variable for the second adjustment means is set at the second timing. The interval between the first timing and the third timing is not longer than one combustion cycle of the internal combustion engine. Therefore, the target torque can be achieved by the controlled variable for the second adjustment means, which is set at the second or third timing, even if the target torque changes during one combustion cycle after the controlled variable for the first adjustment means is set. In addition, the target torque can be accurately achieved because the controlled variable for the second adjustment means is set in accordance with the target torque for the third timing.

According to the sixth aspect of the present invention, the controlled variable for the second adjustment means is further set at the third timing after the controlled variable for the second adjustment means is set at the second timing. The interval between the first timing and the third timing is not longer than one combustion cycle of the internal combustion engine. Therefore, the target torque can be achieved by the controlled variable for the second adjustment means, which is set at the second or third timing, even if the target torque changes during one combustion cycle after the controlled variable for the first adjustment means is set. In addition, the target torque can be accurately achieved because the controlled variable for the second adjustment means is set in accordance with the torque estimated at the third timing.

The seventh aspect of the present invention sets the controlled variable for the second adjustment means at the second or third timing in consideration of the operation mode of an internal combustion engine having a lean-burn capability. Therefore, the seventh aspect of the present invention can accurately achieve the target torque while implementing the operation mode.

When the controlled variable for the fuel injection means, which is set at the second or third timing, makes the air-fuel ratio lower than a predetermined value, the eighth aspect of the present invention preferentially sets the controlled variable for the ignition means at the second or third timing. This makes it possible to accurately achieve the target torque while preventing the deterioration of emission characteristics.

If the controlled variable for the ignition means is judged to be unattainable no matter whether it is to be preferentially set, the ninth aspect of the present invention sets the controlled variable for the fuel injection means at the second or third timing. This assures that the target torque can be accurately achieved while providing catalyst protection.

When the controlled variable for the fuel injection means, which is set at the second or third timing, makes the air-fuel ratio lower than a predetermined value, the tenth aspect of the present invention preferentially sets the controlled variable for the exhaust variable valve mechanism at the second or third timing. This makes it possible to accurately achieve the target torque while preventing the deterioration of emission characteristics.

If the controlled variable for the exhaust variable valve mechanism is judged to be unattainable no matter whether it is to be preferentially set, the eleventh aspect of the present invention sets the controlled variable for the fuel injection means at the second or third timing. This assures that the target torque can be accurately achieved while allowing the emission characteristics to deteriorate to some degree.

The twelfth aspect of the present invention preferentially sets the controlled variable for the ignition means at the second or third timing. Control provided by the ignition means exhibits a higher air-fuel ratio control capability than control provided by the intake variable valve mechanism. Therefore, the twelfth aspect of the present invention can accurately achieve the target torque while preventing the deterioration of emission characteristics.

If the controlled variable for the ignition means is judged to be unattainable from the viewpoint of OT or the like no matter whether it is to be preferentially set, the thirteenth aspect of the present invention sets the controlled variable for the intake variable valve mechanism at the second or third timing. This assures that the target torque can be accurately achieved while providing catalyst protection.

### BRIEF DESCRIPTION OF THE DRAWINGS

FIG. 1 is a diagram for explaining the configuration of a system according to a first embodiment of the present invention;

FIG. 2 is a timing diagram illustrating the conventional torque base control;

FIG. 3 is a timing diagram for explaining the torque base control executed by the first embodiment of the present invention;

FIG. 4 is a flowchart illustrating a routine executed by the ECU 60 in the first embodiment of the present invention;

FIG. 5 is a flowchart illustrating a routine executed by the ECU 60 in a first modification of the first embodiment of the present invention;

FIG. 6 is a flowchart illustrating a routine executed by the ECU 60 in a second modification of the first embodiment of the present invention;

FIG. 7 is a timing diagram for explaining the torque base control executed by a second embodiment of the present invention;

FIG. 8 is a flowchart illustrating a routine executed by the ECU 60 in the second embodiment of the present invention;

FIG. 9 is a diagram for explaining the configuration of a system according to a first modification of the second embodiment of the present invention;

FIG. 10 is a diagram for explaining the configuration of a system according to a second modification of the second embodiment of the present invention;

FIG. 11 is a timing diagram for explaining the torque base control executed by a third embodiment of the present invention;

FIG. 12 is a map that defines the operation modes to be used when the third embodiment calculates the target basic injection amount;

FIG. 13 is a flowchart illustrating a routine executed by the ECU 60 in the third embodiment of the present invention;

FIG. 14 is a timing diagram for explaining the torque base control executed by a fourth embodiment of the present invention;

FIG. 15 is a flowchart illustrating a routine executed by the ECU 60 in the fourth embodiment of the present invention;

FIG. 16 is a timing diagram for explaining the torque base control executed by a fifth embodiment of the present invention;

FIG. 17 is a flowchart illustrating a routine executed by the ECU 60 in the fifth embodiment of the present invention;

FIG. 18 shows a swirl control valve 25, which is installed in the intake path 28 shown in FIG. 1 in accordance with the sixth embodiment of the present invention;

FIG. 19 is a timing diagram for explaining the torque base control executed by the sixth embodiment of the present invention;

FIG. 20 is a flowchart illustrating a routine executed by the ECU 60 in the sixth embodiment of the present invention;

FIG. 21 is a timing diagram for explaining the torque base control executed by a seventh embodiment of the present invention;

FIG. 22 is a flowchart illustrating a routine executed by the ECU 60 in the seventh embodiment of the present invention;

FIG. 23 is a flowchart illustrating a routine executed by the ECU 60 in an eighth embodiment of the present invention;

FIG. 24 is a flowchart illustrating a routine executed by the ECU 60 in a ninth embodiment of the present invention;

FIG. 25 is a flowchart illustrating a routine executed by the ECU 60 in a tenth embodiment of the present invention;

FIG. 26 is a flowchart illustrating a routine executed by the ECU 60 in a eleventh embodiment of the present invention; and

FIG. 27 is a flowchart illustrating a routine executed by the ECU 60 in a twelfth embodiment of the present invention.

### DESCRIPTION OF REFERENCE NUMERALS

1 Internal combustion engine

16 In-cylinder injector

18 Ignition plug

22 Intake valve

24 Variable valve mechanism

25 SCV

26 Port injector

32 Throttle valve

34 Throttle motor

44 Exhaust valve

46 Variable valve mechanism

60 ECU

### BEST MODE FOR CARRYING OUT THE INVENTION

Embodiments of the present invention will now be described with reference to the accompanying drawings. Like elements in the drawings are designated by the same reference numerals and will not be redundantly described.

### First Embodiment

### [Description of System Configuration]

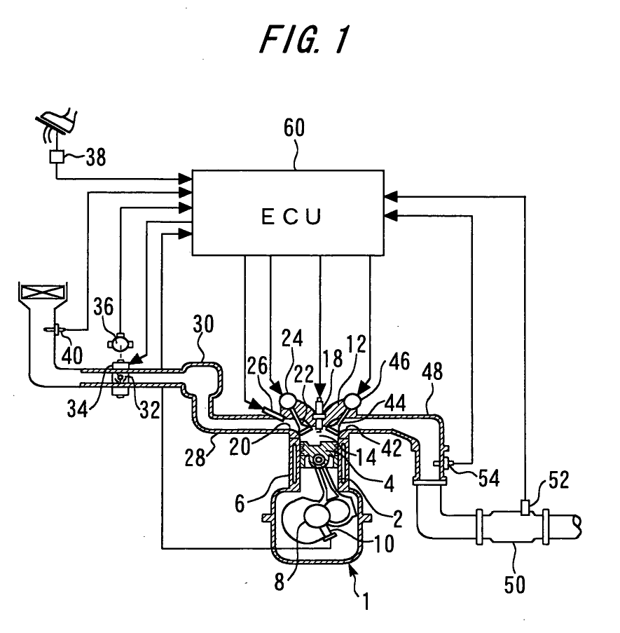

FIG. 1 is a diagram illustrating the configuration of a system according to a first embodiment of the present invention. The system shown in FIG. 1 includes an internal combustion engine 1 (hereinafter referred to as the “engine”), which is a spark ignition type gasoline engine mounted in a vehicle. The engine 1 includes a plurality of cylinders 2. FIG. 1 shows only one of the cylinders.

The engine 1 also includes a cylinder block 6, which contains a piston 4. The piston 4 is connected to a crankshaft 8 through a crank mechanism. A crank angle sensor 10 is installed near the crankshaft 8. The crank angle sensor 10 is configured to detect the rotation angle (crank angle or CA) of the crankshaft 8.

A cylinder head 12 is attached to the top of the cylinder block 6. The space between the upper surface of the piston 4 and the cylinder head 12 forms a combustion chamber 14. The cylinder head 12 includes an ignition plug 18, which ignites an air-fuel mixture in the combustion chamber 14.

The cylinder head 12 has an intake port 20 that communicates with the combustion chamber 14. An intake valve 22 is mounted on the joint between the intake port 20 and the combustion chamber 14. The intake valve 22 is provided with a variable valve mechanism 24 that can change the valve opening characteristics (valve opening/closing timing and lift amount) of the intake valve 22.

The intake port 20 includes a port injector 26, which injects fuel to the vicinity of the intake port 20. The intake port 20 is connected to an intake path 28. A surge tank 30 is installed in the middle of the intake path 28. A throttle valve 32 is installed upstream of the surge tank 30. The throttle valve 32 is an electronically controlled valve that is driven by a throttle motor 34. The throttle valve 32 is driven in accordance with an accelerator angle AA that is detected by an accelerator angle sensor 38. A throttle angle sensor 36 is installed near the throttle valve 32 to detect a throttle angle TA.

An air flow meter 40 is installed upstream of the throttle valve 32. The air flow meter 40 is configured to detect an intake air amount (hereinafter abbreviated to the “intake amount”) Ga.

The cylinder head 12 also has an exhaust port 42 that communicates with the combustion chamber 14. An exhaust valve 44 is mounted on the joint between the exhaust port 42 and the combustion chamber 14. The exhaust valve 44 is provided with a variable valve mechanism 46 that can change the valve opening characteristics (valve opening/closing timing and lift amount) of the exhausts valve 44. The exhaust port 42 is connected to an exhaust path 48. An exhaust purification catalyst (hereinafter abbreviated to the “catalyst”) 50 is installed in the exhaust path 48 to purify exhaust gas. An air-fuel ratio sensor 54 is installed upstream of the catalyst 50 to detect an exhaust air-fuel ratio.

The system according to the present embodiment also includes an ECU (Electronic Control Unit) 60, which serves as a control device. The output end of the ECU 60 is connected, for instance, to the ignition plug 18, port injector 26, variable valve mechanisms 24, 46, and throttle motor 34. The input end of the ECU 60 is connected, for instance, to the crank angle sensor 10, throttle angle sensor 36, accelerator angle sensor 38, air flow meter 40, and air-fuel ratio sensor 54.

The ECU 60 calculates an engine rotation speed NE in accordance with the crank angle CA. The ECU 60 also calculates a load KL required of the engine 1 in accordance, for instance, with the accelerator angle AA. Further, in accordance, for instance, with the intake amount Ga, the ECU 60 estimates the torque to be generated by the engine 1.

### Features of First Embodiment

In the system described above, the ECU 60 calculates a target torque or a target output in accordance with the accelerator angle AA and the operating status of the vehicle. The following description deals with only the target torque and excludes the target output (the same holds for the other embodiments, which will be described later).

To achieve the target torque, the ECU 60 calculates the controlled variables for various actuators (ignition plug 18, port injector 26, throttle motor 34, and variable valve mechanisms 26, 46) that can adjust the torque to be generated by the engine 1, and sets the calculated controlled variables for the actuators (this operation is hereinafter referred to as “torque base control”), as described later.

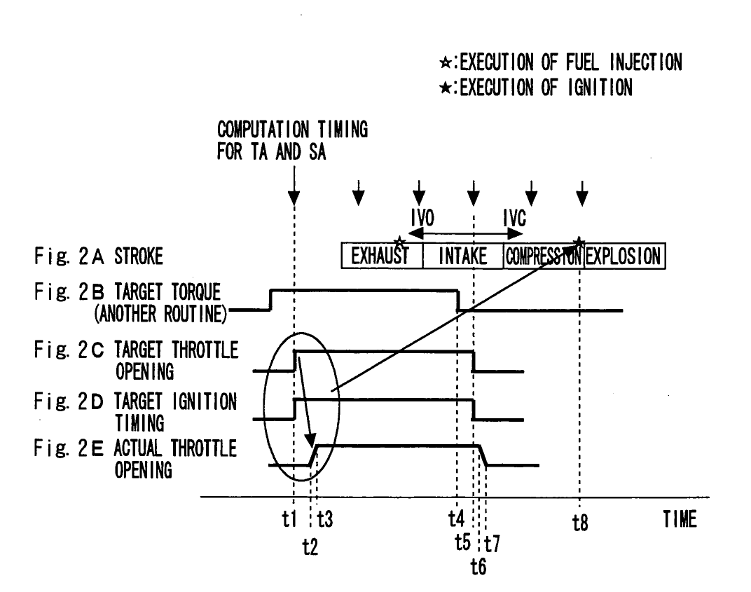

During conventional torque base control, which is represented by control provided by the device described in Patent Document 1, a plurality of controlled variables (e.g., target throttle angle and target ignition timing) for achieving a target torque are simultaneously set as shown in FIG. 2. FIG. 2 is a timing diagram illustrating the conventional torque base control. A plurality of downward arrows in FIG. 2 indicate the calculation (computation) timing for the target throttle angle and target ignition timing.

According to the conventional torque base control, the target throttle angle and the target ignition timing are simultaneously calculated in accordance with the target torque at time t1, which precedes an exhaust stroke. The calculated target throttle angle is then set for the throttle motor, whereas the calculated target ignition timing is set for the ignition plug. Subsequently, the throttle motor is driven between time t2 and time t3 to exercise control so that the actual throttle angle agrees with the target throttle angle calculated at time t1. In addition, the ignition plug performs ignition at time t8, which represents the target ignition timing calculated at time t1.

As described above, the conventional torque base control is exercised to provide throttle control in accordance with the target throttle angle calculated at time t1 and perform ignition in accordance with the target ignition timing, which is calculated simultaneously with the target throttle angle.

Meanwhile, the target torque may change at time t4, which comes after actual throttle angle control between time t2 and time t3, as shown in FIG. 2. If such a change occurs, the target throttle angle and target ignition timing are calculated at time t5, which comes immediately after time t4. Throttle angle control is then exercised between time t6 and time t7 so that the actual throttle angle agrees with the target throttle angle calculated at time t5.

However, the air response and torque response of the actual throttle angle changed between time t6 and time t7 are low. More specifically, even if the actual throttle angle is changed between time t6 and time t7, the intake air has already passed through the throttle valve; therefore, the amount of air flowing into the combustion chamber (hereinafter referred to as the “cylinder”) cannot be changed. Accordingly, the torque generated during an explosion stroke subsequent to time t8 is equal to the target torque prevailing at time t1 and significantly different from the target torque prevailing at time t5. It means that the conventional torque base control may not accurately achieve a target torque.

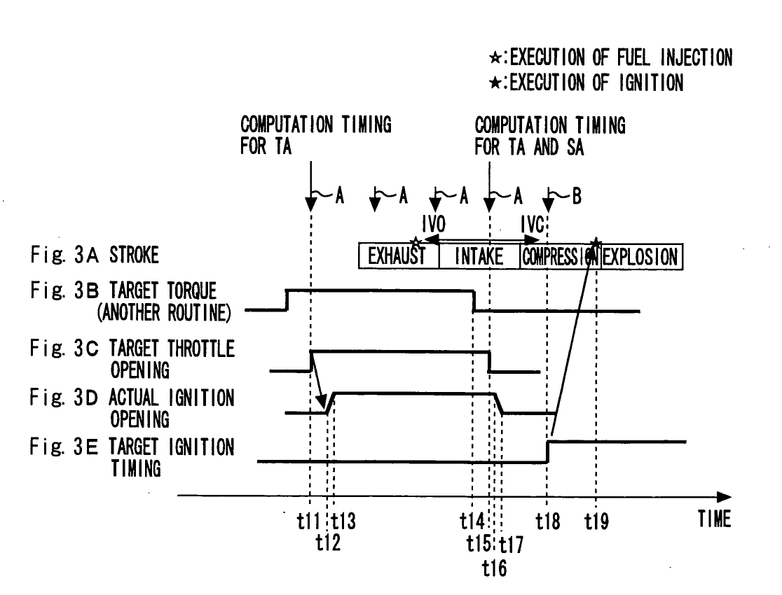

In view of the above circumstances, the first embodiment exercises torque base control as depicted in FIG. 3. FIG. 3 is a timing diagram for explaining the torque base control executed by the present first embodiment. More specifically, this figure shows strokes in FIG. 3(A), target torque changes in FIG. 3(B), target throttle angle changes in FIG. 3(C), actual throttle angle changes in FIG. 3(D), and target ignition timing changes in FIG. 3(E).

A plurality of arrows A in the figure indicate the calculation (computation) timing for the target throttle angle. An arrow B, on the other hand, indicates the calculation timing for the target throttle angle and target ignition timing. The same holds for the other embodiments, which will be described later.

At time t11, the target throttle angle, which has a relatively low torque response, is calculated in accordance with the target torque as shown in FIG. 3(C). The calculated target throttle angle is then set for the throttle motor 34. Unlike the conventional torque base control (see FIG. 2), the target ignition timing is not calculated at time t11.

Subsequently, the throttle motor 34 is driven between time t12 and time t13 as shown in FIG. 3(D) to exercise control so that the actual throttle angle agrees with the target throttle angle calculated at time t11.

Afterward, the target torque changes (decreases) at time t14 as shown in FIG. 3(B). Then, the target throttle angle is calculated at time t15 to suggest a small target throttle angle as shown in FIG. 3(C). Throttle angle control is then exercised between time t16 and time t17 so that the actual throttle angle agrees with the target throttle angle calculated at time t15.

It is be noted that the throttle control described above has a low torque response and therefore does not affect the torque generated during the immediately following explosion stroke. In other words, as the intake air has already passed through the throttle valve 32, the target torque decreased at time t14 cannot be achieved simply by changing the actual throttle angle between time t16 and time t17.

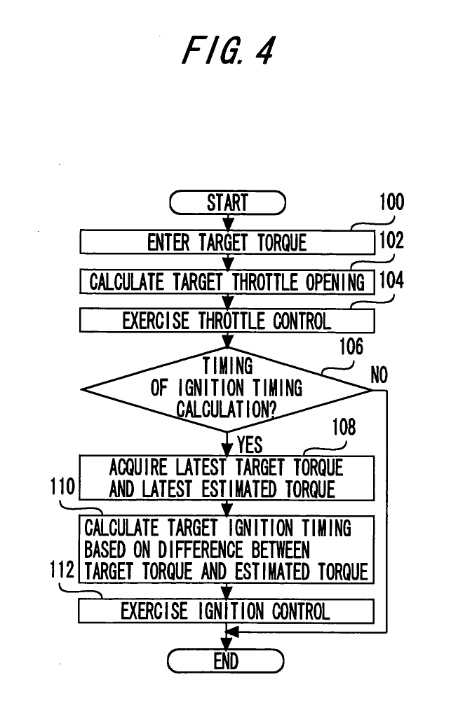

However, the first embodiment calculates the target ignition timing, which has a high torque response, at time t18 during a compression stroke and sets the calculated target ignition timing for the ignition plug 18 as shown in FIG. 3(E). The target ignition timing is calculated in accordance with the target torque prevailing at time t18 (the latest target torque) and the torque estimated at time t18 (the latest estimated torque). More specifically, the target ignition timing is calculated in accordance with the difference between the target torque and estimated torque prevailing at time t18 (see FIG. 4). Subsequently, the ignition plug 18 performs ignition at time t19, which represents the target ignition timing calculated at time t18.

The first embodiment calculates the target ignition timing at time t18 at which the amount of air flowing into the cylinder cannot be changed, and performs ignition at time t19, which represents the calculated target ignition timing. This makes it possible to achieve the target torque that was decreased at time t14.

### Details of Process Performed by First Embodiment

FIG. 4 is a flowchart illustrating a routine that the ECU 60 executes in accordance with the first embodiment. The routine starts at timings indicated, for instance, by arrows A and B in FIG. 3.

First of all, the routine shown in FIG. 4 performs step 100 to input the target torque. The target torque is calculated by another routine. Next, the routine performs step 102 to calculate the target throttle angle in accordance with the target torque inputted in step 100. Then, the routine performs step 104 to exercise throttle control. In step 104, the target throttle angle calculated in step 102 is set for the throttle motor 34.

Next, the routine performs step 106 to judge whether the current time represents the timing of ignition timing calculation. For example, time t18, which is indicated by arrow B in FIG. 3, represents the timing of ignition timing calculation. If the judgment result obtained in step 106 does not indicate that the current time represents the timing of ignition timing calculation, that is, if the current time is time t11, time t15, or other time indicated by arrows A in FIG. 3, the routine terminates.

If, on the other hand, the judgment result obtained in step 106 indicates that the current time represents the timing of ignition timing calculation, the routine performs step 108 to acquire the latest target torque and estimated torque. Next, the routine performs step 110 to determine the difference between the target torque and estimated torque, which were acquired in step 108, and calculate the target ignition timing in accordance with the difference. Subsequently, the routine performs step 112 to exercise ignition control. In step 112, the target ignition timing calculated in step 110 is set for the ignition plug 18. Upon completion of step 112, the routine terminates.

As described above, the first embodiment calculates the target throttle angle at time t11, which precedes an exhaust stroke, and then calculates the target ignition timing at time t18 during a compression stroke. The target ignition timing is calculated in consideration of the latest target torque and estimated torque prevailing during the compression stroke. Therefore, even if the target torque is changed due, for instance, to disturbance after target throttle angle calculation at time t11, the target ignition timing can be calculated later to accurately achieve the changed target torque.

In addition, even if the target torque is decreased after the throttle valve 32 is opened, the first embodiment can accurately achieve the target torque.

The first embodiment calculates the ignition timing in accordance with the difference between the latest target torque and estimated torque. However, an alternative routine shown in FIG. 5 may be executed to calculate the target ignition timing (step 110A) in accordance with only the latest target torque acquired in step 108A. FIG. 5 is a flowchart illustrating a routine that the ECU 60 executes in accordance with a first modification of the first embodiment.

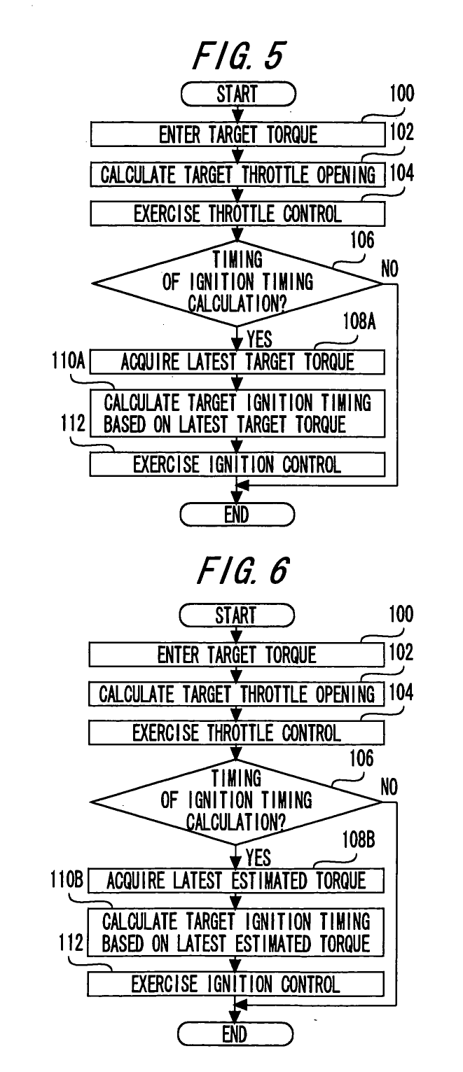

Another alternative would be to calculate the target ignition timing in accordance with the latest estimated torque. More specifically, another alternative routine shown in FIG. 6 may be executed to calculate the difference between a non-latest target torque (e.g., target torque prevailing at time t11) and the latest estimated torque acquired in step 108B (e.g., the torque estimated at time t18) and calculate the ignition timing in accordance with the difference (step 110B). FIG. 6 is a flowchart illustrating a routine that the ECU 60 executes in accordance with a second modification of the first embodiment.

The above modifications of the first embodiment provide the same advantages as the first embodiment because they also calculate the target ignition timing and set the calculated target ignition timing for the ignition plug while the amount of air flowing into the cylinder cannot be changed.

The other embodiments (second to twelfth embodiments) will be described later with exclusive reference to a situation where the difference between the latest target torque and estimated torque is determined to calculate the target ignition timing, target injection amount, target IVC, or other controlled variable having a high torque response in accordance with the difference. However, the other embodiments (second to twelfth embodiments) may also be used to calculate a controlled variable having a high torque response in accordance with the latest target torque or the latest estimated torque as is the case with the modifications of the first embodiment.

In the first embodiment and its modifications, the ECU 60 corresponds to the “torque estimation means” according to the first and third aspects of the present invention; the throttle valve 32 and throttle motor 34 correspond to the “first adjustment means” according to the first, second, and third aspects of the present invention; and the ignition plug 18 corresponds to the “second adjustment means” according to the first, second, and third aspects of the present invention.

Further, in the first embodiment, the “target torque acquisition means” according to the first, second, and third aspects of the present invention is implemented when the ECU 60 performs steps 100, 108, 108A, and 108B; and the “controlled variable setup means” according to the first aspect of the present invention is implemented when the ECU 60 performs steps 102, 104, 110, and 112.

In the modifications of the first embodiment, the “controlled variable setup means” according to the second aspect of the present invention is implemented when the ECU 60 performs steps 102, 104, 110A, and 112; and the “controlled variable setup means” according to the third aspect of the present invention is implemented when the ECU 60 performs steps 102, 104, 110B, and 112.

### Second Embodiment

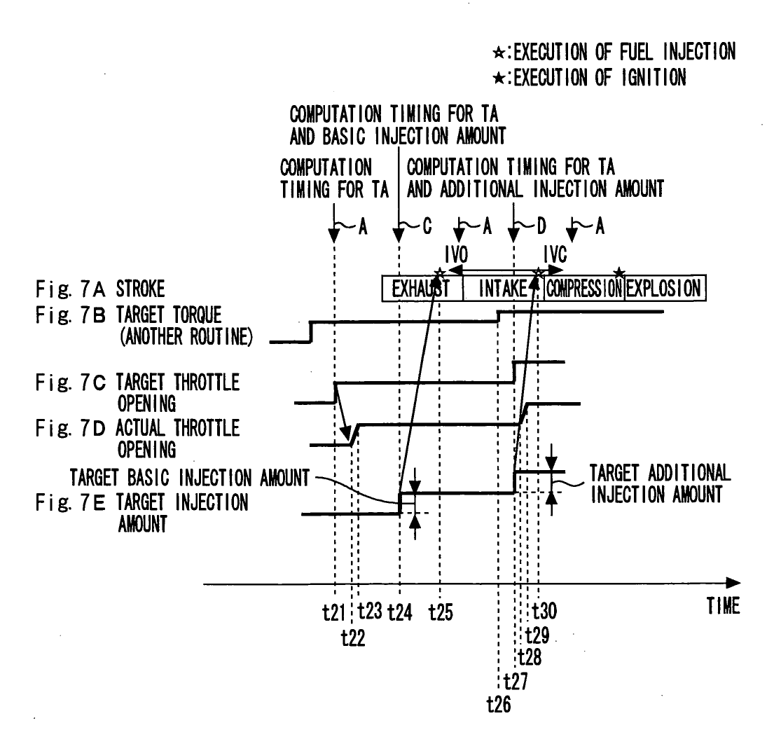

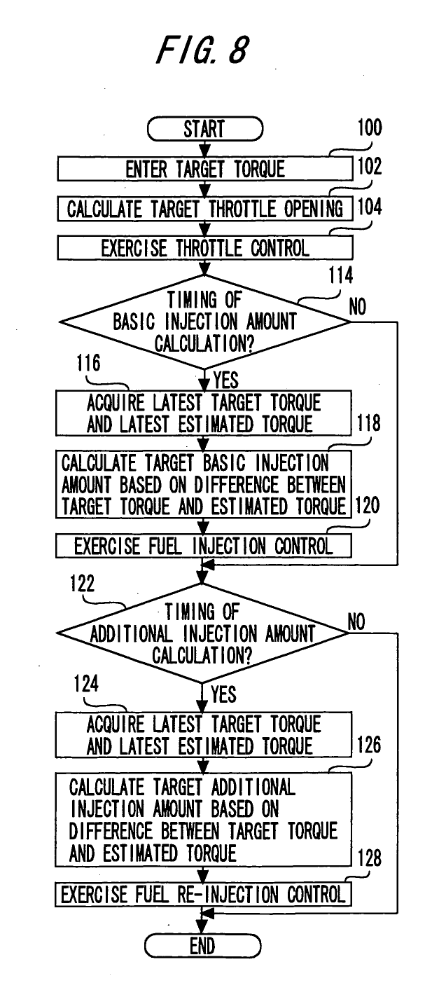

A second embodiment of the present invention will now be described with reference to FIGS. 7 and 8. The system according to the second embodiment is implemented when the hardware configuration shown in FIG. 1 is employed to let the ECU 60 execute a later-described routine shown in FIG. 8.

### Features of Second Embodiment

The first embodiment, which has been described earlier, calculates the target ignition timing, which has a relatively high torque response, after calculating the target throttle angle, which has a relatively low torque response.

The second embodiment will be described with reference to a situation where a target injection amount is used instead of the target ignition timing as a controlled variable having a relatively high torque response.

The second embodiment exercises torque base control as depicted in FIG. 7. FIG. 7 is a timing diagram illustrating how the second embodiment exercises torque base control. More specifically, this figure shows strokes in FIG. 7(A), target torque changes in FIG. 7(B), target throttle angle changes in FIG. 7(C), actual throttle angle changes in FIG. 7(D), and target injection amount changes in FIG. 7(E).

An arrow C in the figure indicates the calculation timing for the throttle angle and basic injection amount. An arrow D, on the other hand, indicates the calculation timing for the throttle angle and additional injection amount.

At time t21, which precedes an exhaust stroke, the target throttle angle is calculated in accordance with the target torque to set the calculated target throttle angle for the throttle motor 34 as shown in FIG. 7(C). At time t21, only the target throttle angle is calculated without calculating the target injection amount.

Subsequently, the throttle motor 34 is driven between time t22 and time t23 to exercise control so that the actual throttle angle agrees with the target throttle angle calculated at time t21 as shown in FIG. 7(D).

Subsequently, the target injection amount (hereinafter referred to as the “target basic injection amount”) is calculated at time t24 during an exhaust stroke as shown in FIG. 7(E). The target basic injection amount is calculated in accordance with the difference between the target torque and estimated torque prevailing at time t24. The calculated target basic injection amount is then set for the port injector 26. Subsequently, at time t25, fuel injection control is exercised in accordance with the target injection amount calculated at time t24.

Afterward, the target torque is changed (increased) at time t26 as shown in FIG. 7(B). Subsequently, at time t27 during an intake stroke, the target injection amount (hereinafter referred to as the “target additional injection amount”), which has a higher torque response than the throttle angle, is calculated as shown in FIG. 7(E). More specifically, the target additional injection amount is calculated in accordance with the difference between the latest target torque and estimated torque prevailing at time t27. The calculated target additional injection amount is then set for the port injector 26.

Further, the target throttle angle is calculated at time t27 together with the above-mentioned target additional injection amount to suggest a large target throttle angle as shown in FIG. 7(C). Throttle angle control is then exercised between time t28 and time t29 as shown in FIG. 7(D) so that the actual throttle angle agrees with the target throttle angle calculated at time t27.

Subsequently, at time t30, fuel re-injection is performed in accordance with the target additional injection amount calculated at time t27. This fuel re-injection can be performed until immediately before intake valve closing (IVC).

It is be noted that the throttle control described above has a low torque response and therefore does not affect the torque generated during the immediately following explosion stroke. In other words, as the intake air has already passed through the throttle valve 32, the target torque increased at time t26 cannot be achieved simply by changing the actual throttle angle between time t28 and time t29.

However, the second embodiment calculates the target additional injection amount, which has a high torque response, at time t27, which comes after a target torque change, and sets the calculated target additional injection amount for the port injector 26. This makes it possible to achieve the target torque that is increased at time t26.

### Details of Process Performed by Second Embodiment

FIG. 8 is a flowchart illustrating a routine that the ECU 60 executes in accordance with the second embodiment. The routine starts at timings indicated, for instance, by arrows A, C, and D in FIG. 7.

In accordance with the target torque entered in step 100, the routine shown in FIG. 8 performs step 102 to calculate the target throttle angle. The routine then performs step 104 to exercise throttle control.

Next, the routine performs step 114 to judge whether the current time represents the timing of basic injection amount calculation. For example, time t24, which is indicated by the arrow C in FIG. 7, represents the timing of basic injection amount calculation. If the judgment result obtained in step 114 does not indicate that the current time represents the timing of basic injection amount calculation, the routine proceeds to step 122, which will be described later.

If, on the other hand, the judgment result obtained in step 114 indicates that the current time represents the timing of basic injection amount calculation, the routine performs step 116 to acquire the latest target torque and estimated torque in the same manner as in step 108 of the routine shown in FIG. 4. Next, the routine performs step 118 to determine the difference between the target torque and estimated torque, which were acquired in step 116, and calculate the target basic injection amount in accordance with the difference. Subsequently, the routine performs step 120 to exercise fuel injection control. In step 120, the target basic injection amount calculated in step 118 is set for the port injector 26.

Next, the routine performs step 122 to judge whether the current time represents the timing of additional injection amount calculation. For example, time t27, which is indicated by the arrow D in FIG. 7, represents the timing of additional injection amount calculation. If the judgment result obtained in step 122 does not indicate that the current time represents the timing of additional injection amount calculation, the routine terminates.

If, on the other hand, the judgment result obtained in step 122 indicates that the current time represents the timing of additional injection amount calculation, the routine performs step 124 to acquire the latest target torque and estimated torque in the same manner as in step 116. Next, the routine performs step 126 to determine the difference between the target torque and estimated torque, which were acquired in step 124, and calculate the target additional injection amount in accordance with the difference. Subsequently, the routine performs step 128 to exercise fuel re-injection control. In step 128, the target additional injection amount calculated in step 126 is set for the port injector 26. Upon completion of step 128, the routine terminates.

As described above, after the target throttle angle is calculated at time t21, which precedes an exhaust stroke, the second embodiment calculates the target basic injection amount at time t24 during the exhaust stroke and then calculates the target additional injection amount at time t27 during an intake stroke. The target basic injection amount is calculated in consideration of the latest target torque and estimated torque prevailing during the exhaust stroke, whereas the target additional injection amount is calculated in consideration of the latest target torque and estimated torque prevailing during the intake stroke. Therefore, even if the target torque is changed due, for instance, to disturbance after target throttle angle calculation at time t21, the target injection amounts (target basic injection amount and target additional injection amount) can be calculated later to accurately achieve the changed target torque.

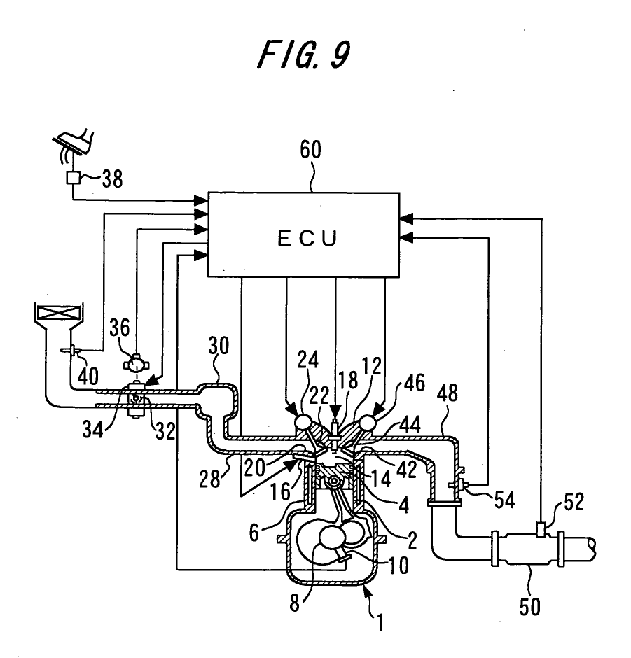

The second embodiment has been described on the assumption that the system having the port injector 26 is used. However, the system having an in-cylinder injector 16 shown in FIG. 9 may be used instead of the port injector 26. FIG. 9 is a diagram illustrating the configuration of the system according to a first modification of the second embodiment. As shown in FIG. 9, the in-cylinder injector 16 is configured to directly inject fuel into the combustion chamber 14.

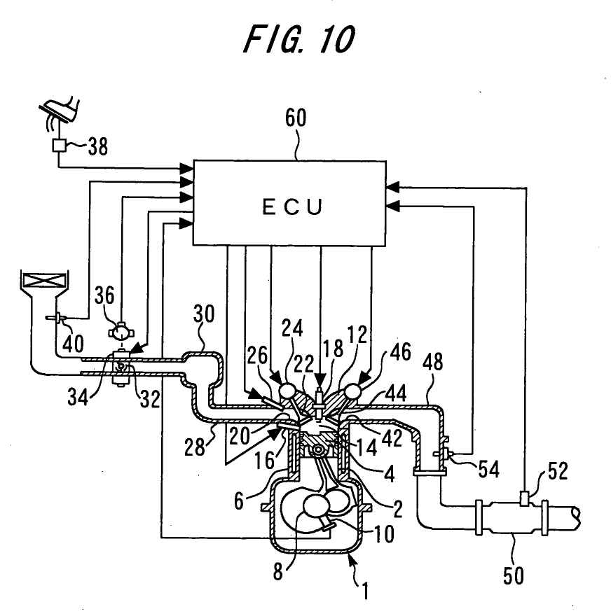

Further, the system having both the port injector 26 and in-cylinder injector 16 as shown in FIG. 10 may also be used. FIG. 10 is a diagram illustrating the configuration of the system according to a second modification of the second embodiment.

The use of the in-cylinder injector 16 makes it possible to exercise fuel injection control and fuel re-injection control until immediately before ignition timing.

In the second embodiment and its modifications, the ECU 60 corresponds to the “torque estimation means” according to the first aspect of the present invention; the throttle valve 32 and throttle motor 34 correspond to the “first adjustment means” according to the first aspect of the present invention; and the port injector 26 and in-cylinder injector 16 correspond to the “second adjustment means” according to the first and fourth aspects of the present invention.

Further, in the second embodiment and its modifications, the “torque acquisition means” according to the first aspect of the present invention is implemented when the ECU 60 performs steps 100, 116, and 124; the “controlled variable setup means” according to the first aspect of the present invention is implemented when the ECU 60 performs steps 102, 104, 118, and 120; and the “controlled variable setup means” according to the fourth aspect of the present invention is implemented when the ECU 60 performs steps 126 and 128.

### Third Embodiment

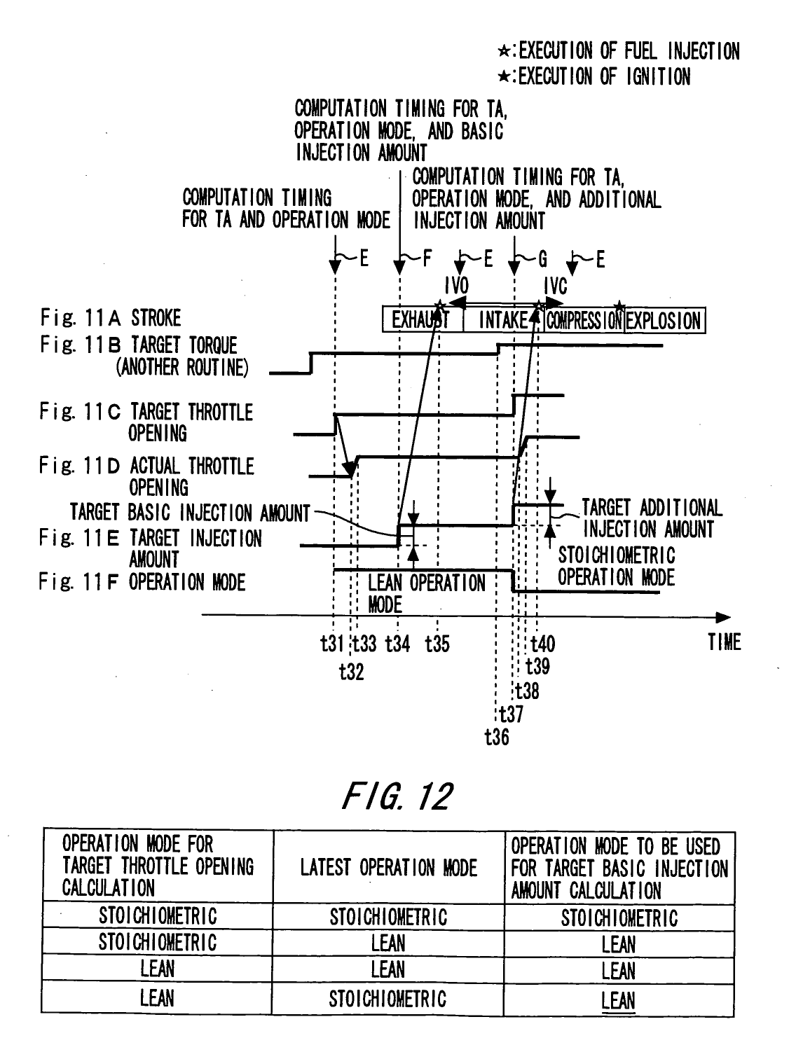

A third embodiment of the present invention will now be described with reference to FIGS. 11 to 13.

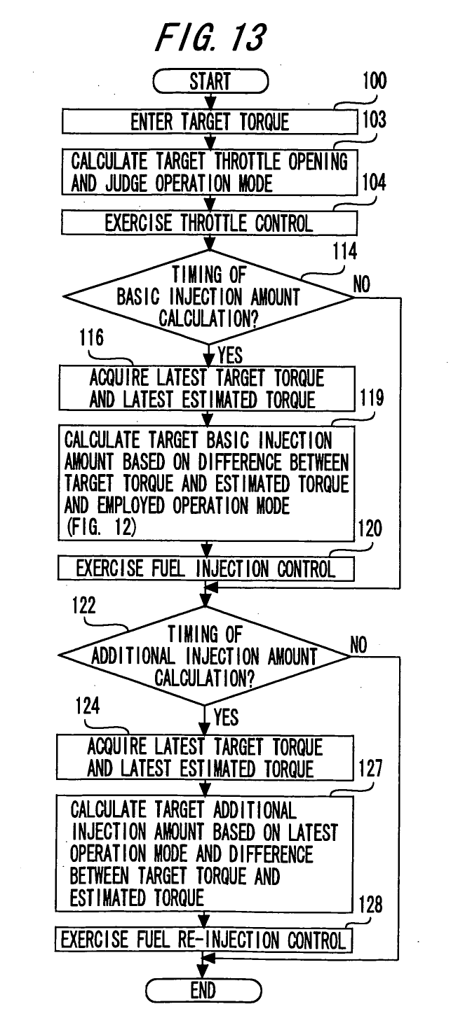

The system according to the third embodiment is implemented when the hardware configuration shown in FIG. 1 is employed to let the ECU 60 execute a later-described routine shown in FIG. 13.

### Features of Third Embodiment

The system according to the third embodiment can execute a plurality of operation modes. More specifically, it can execute not only a stoichiometric operation mode, in which an operation is conducted at a stoichiometric air-fuel ratio, but also a lean operation mode, in which an operation is conducted at an air-fuel ratio leaner than the stoichiometric air-fuel ratio. The ECU 60 determines the operation mode to be used in accordance, for instance, with the operating status of the engine 1.

The third embodiment exercises torque base control as shown in FIG. 11. FIG. 11 is a timing diagram illustrating how the third embodiment exercises torque base control. More specifically, this figure shows strokes in FIG. 11(A), target torque changes in FIG. 11(B), target throttle angle changes in FIG. 11(C), actual throttle angle changes in FIG. 11(D), target injection amount changes in FIG. 11(E), and operation mode changes in FIG. 11(F).

Arrows E in the figure indicate the calculation timing for the throttle angle and operation mode. An arrow F indicates the calculation timing for the throttle angle, operation mode, and basic injection amount. An arrow G indicates the calculation timing for the throttle angle, operation mode, and additional injection amount.

At time t31, the target throttle angle is calculated in accordance with the target torque to set the calculated target throttle angle for the throttle motor 34 as shown in FIG. 11(C). The lean operation mode is calculated (selected) as the operation mode for time t31. Neither the target basic injection amount nor the target additional injection amount is calculated at time t31.

Subsequently, the throttle motor 34 is driven between time t32 and time t33 to exercise control so that the actual throttle angle agrees with the target throttle angle calculated at time t31.

Subsequently, the target basic injection amount is calculated at time t34 during an exhaust stroke as shown in FIG. 11(E). The target basic injection amount is calculated in consideration of not only the latest target torque and estimated torque but also the operation modes shown in FIG. 12. FIG. 12 is a map that defines the operation modes to be used when the third embodiment calculates the target basic injection amount. The map shown in FIG. 12 indicates that the operation mode to be used for calculating the target basic injection amount is determined in accordance with the operation mode for initial target throttle angle calculation (at time t31) and the latest operation mode (prevailing at time t34).

If the operation mode used for target throttle angle calculation is the same as the latest operation mode, the map shown in FIG. 12 uses that operation mode for target basic injection amount calculation because it is highly probable that a steady-state operation will continue. Further, if the stoichiometric operation mode prevails during target throttle angle calculation whereas the latest operation mode is the lean operation mode, the map uses the lean operation mode for target basic injection amount calculation. For the above three patterns, the latest operation mode is used as is during target basic injection amount calculation.

If, on the other hand, the lean operation mode prevails during target throttle angle calculation whereas the latest operation mode is the stoichiometric operation mode, the map uses the lean operation mode for target basic injection amount calculation. The reason is that it is considerable that the possibility that the change to the stoichiometric operation mode is transiently and the operation mode may change to the lean operation mode before the subsequent calculation of the target additional injection amount is high.

If the stoichiometric operation mode persists as the operation mode for target additional injection amount calculation, such a situation can be properly handled by adjusting the target additional injection amount.

The operation modes at time t31 and at time t34 are both lean. At time t34 during an exhaust stroke, therefore, the map shown in FIG. 12 is referenced to select the lean operation mode. At time t34, the target basic injection amount is calculated in accordance with the difference between the latest target torque and estimated torque and in consideration of the fact that the lean operation mode prevails. The calculated target basic injection amount is then set for the port injector 26.

Subsequently, at time t36, the target torque is changed (increased) as shown in FIG. 11(B). Then, at time t37, the target additional injection amount is calculated as shown in FIG. 11(E). The target additional injection amount is calculated in accordance with the difference between the target torque and estimated torque prevailing at time t37 and in consideration of the lean operation mode prevailing at time t37. The calculated target additional injection amount is then set for the port injector 26.

Further, the target throttle angle is calculated at time t37 together with the above-mentioned target additional injection amount to suggest a large target throttle angle as shown in FIG. 11(C). Throttle angle control is then exercised between time t38 and time t39 as shown in FIG. 11(D) so that the actual throttle angle agrees with the target throttle angle calculated at time t37.

Subsequently, at time t40, fuel injection is performed in accordance with the target additional injection amount calculated at time t37. This fuel injection can be performed until immediately before intake valve closing (IVC).

Meanwhile, throttle control has a low torque response and therefore does not affect the torque generated during the immediately following explosion stroke. In other words, as the intake air has already passed through the throttle valve 32, the target torque increased at time t36 cannot be achieved simply by changing the actual throttle angle between time t38 and time t39.

However, the third embodiment calculates the target additional injection amount, which has a high torque response, at time t37, which comes after a target torque change, and sets the calculated target additional injection amount for the port injector 26. This makes it possible to achieve the target torque that is increased at time t36. Further, the target additional injection amount is calculated in consideration of the latest operation mode (prevailing at time t37). Therefore, the operation mode changed at time t36, that is, the stoichiometric operation mode, can be implemented.

### Details of Process Performed by Third Embodiment

FIG. 13 is a flowchart illustrating a routine that the ECU 60 executes in accordance with the third embodiment. The routine starts at timings indicated, for instance, by arrows E, F, and G in FIG. 11.

In accordance with the target torque inputted in step 100, the routine shown in FIG. 13 performs step 103 to calculate the target throttle angle and judge the operation mode. Subsequently, the routine sequentially performs steps 104, 114, and 116 in the same manner as the routine shown in FIG. 8. Here, time t34, which is indicated, for instance, by arrow F in FIG. 11, represents the timing of basic injection amount calculation in step 114.

Next, the map shown in FIG. 12 is referenced to determine the operation mode to be used for calculating the target basic injection amount. Then, in step 119, the target basic injection amount is calculated in accordance with the determined operation mode and the difference between the latest target torque and estimated torque. Subsequently, step 120 is performed to exercise fuel injection control. In step 120, the target basic injection amount calculated in step 119 is set for the port injector 26.

Next, the routine performs steps 122 and 124 in the same manner as the routine shown in FIG. 8. Here, time t37, which is indicated, for instance, by arrow G in FIG. 11, represents the timing of additional injection amount calculation in step 122.

Subsequently, step 127 is performed to calculate the target additional injection amount in accordance with the latest operation mode and the difference between the latest target torque and estimated torque. Step 128 is then performed to exercise fuel re-injection control. In step 128, the target additional injection amount calculated in step 127 is set for the port injector 26. Upon completion of step 128, the routine terminates.

As described above, after the target throttle angle is calculated at time t31, which precedes an exhaust stroke, the third embodiment calculates the target basic injection amount at time t34 during the exhaust stroke and then calculates the target additional injection amount at time t37 during an intake stroke. The target basic injection amount is calculated in consideration of the latest target torque and estimated torque prevailing during the exhaust stroke and the operation mode defined by the map shown in FIG. 12. Further, the target additional injection amount is calculated in consideration of the latest target torque and estimated torque prevailing during the intake stroke and the latest operation mode. Therefore, even if the target torque is changed due, for instance, to disturbance after target throttle angle calculation at time t31, the target injection amounts (target basic injection amount and target additional injection amount) can be calculated later to accurately achieve the changed target torque. In addition, the operation mode to be used after such a change can be implemented.

The third embodiment has been described on the assumption that the system having the port injector 26 (FIG. 1) is used. However, the system having the in-cylinder injector 16 (see FIGS. 9 and 10) may also be used as is the case with the second embodiment, which has been described earlier. The use of the in-cylinder injector 16 makes it possible to exercise fuel injection control and fuel re-injection control until immediately before ignition timing.

In the third embodiment and its modifications, the ECU 60 corresponds to the “torque estimation means” according to the first aspect of the present invention; the throttle valve 32 and throttle motor 34 correspond to the “first adjustment means” according to the first aspect of the present invention; and the port injector 26 and in-cylinder injector 16 correspond to the “second adjustment means” according to the first and seventh aspects of the present invention.

Further, in the third embodiment and its modifications, the “torque acquisition means” according to the first aspect of the present invention is implemented when the ECU 60 performs steps 100, 116, and 124; the “operation mode judgment means” according to the seventh aspect of the present invention is implemented when the ECU 60 performs step 103; and the “controlled variable setup means” according to the seventh aspect of the present invention is implemented when the ECU 60 performs steps 119, 120, 127, and 128.

### Fourth Embodiment

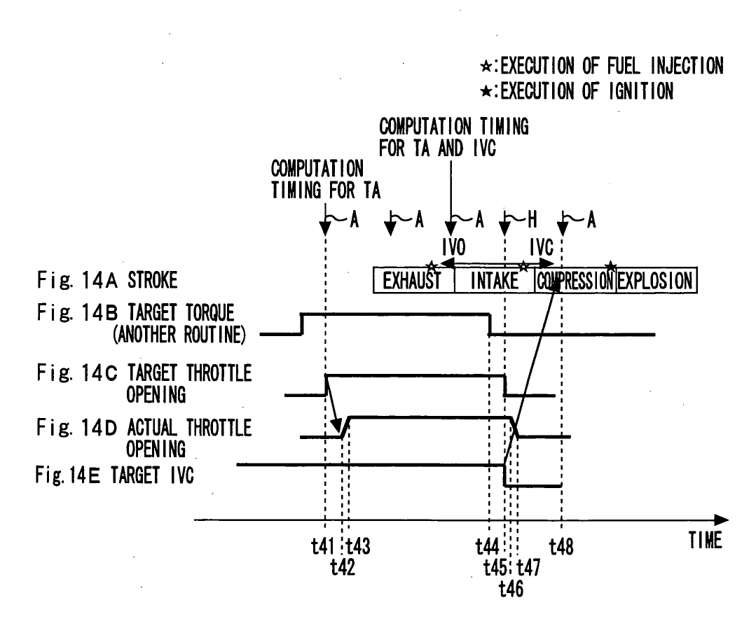

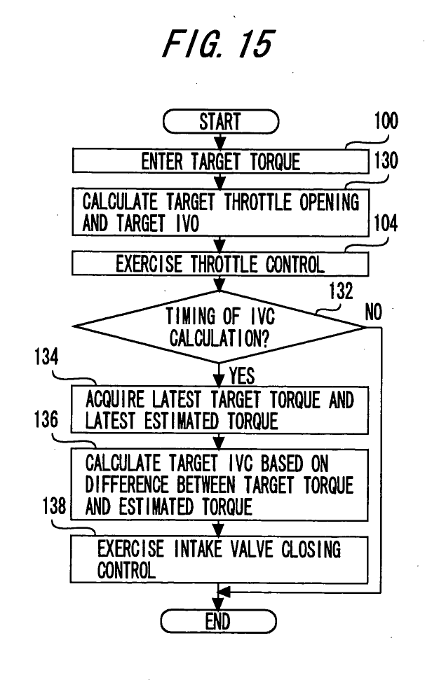

A fourth embodiment of the present invention will now be described with reference to FIGS. 14 and 15.

The system according to the fourth embodiment is implemented when the hardware configuration shown in FIG. 1 is employed to let the ECU 60 execute a later-described routine shown in FIG. 15.

### Features of Fourth Embodiment

The second and third embodiment, which have been described earlier, use the target injection amounts as controlled variables having a relatively high torque response.

The fourth embodiment uses a target closing timing of the intake valve 22 (hereinafter referred to as the “target IVC”) instead of the target injection amounts as a controlled variable having a relatively high torque response. Even after the intake air has passed through the throttle valve 32, the intake valve closing timing (hereinafter referred to as the “IVC”) can be advanced or retarded to decrease the amount of air taken into the cylinder and reduce the torque to be generated during an explosion stroke.

The fourth embodiment exercises torque base control as shown in FIG. 14. FIG. 14 is a timing diagram illustrating how the fourth embodiment exercises torque base control. More specifically, this figure shows strokes in FIG. 14(A), target torque changes in FIG. 14(B), target throttle angle changes in FIG. 14(C), actual throttle angle changes in FIG. 14(D), and target IVC status in FIG. 14(E). An arrow H in the figure indicates the calculation timing for the throttle angle and IVC.

At time t41, which precedes an exhaust stroke, the target throttle angle is calculated in accordance with the target torque to set the calculated target throttle angle for the throttle motor 34 as shown in FIG. 14(C). At time t41, a target opening timing of the intake valve 22 (hereinafter referred to as the “target IVO”) is calculated; however, the target IVC is not calculated.

Subsequently, the throttle motor 34 is driven between time t42 and time t43 to exercise control so that the actual throttle angle agrees with the target throttle angle calculated at time t41 as shown in FIG. 14(D).

As shown in FIG. 14(B), the target torque is decreased afterward at time t44 during an intake stroke. Then, at time t45, the target IVC, which has a higher torque response than the throttle angle, is calculated as shown in FIG. 14(E) to set the calculated target IVC for the variable valve mechanism 24. The target IVC is calculated in accordance with the difference between the latest target torque and estimated torque prevailing at time t45.

Further, the target throttle angle is calculated at time t45 together with the above-mentioned target IVC to suggest a small target throttle angle as shown in region (C) of FIG. 14. Throttle angle control is then exercised between time t46 and time t47 as shown in FIG. 14(D) so that the actual throttle angle agrees with the target throttle angle calculated at time t45.

Subsequently, at time t48, which represents the target IVC calculated at time t45, the intake valve 22 closes.

Meanwhile, the throttle control described above has a low torque response and therefore does not affect the torque generated during the immediately following explosion stroke. In other words, as the intake air has already passed through the throttle valve 32, the target torque decreased at time t44 cannot be achieved simply by changing the actual throttle angle between time t46 and time t47.

However, the fourth embodiment calculates the target IVC, which has a high torque response, at time t45, which comes after a change in the target torque, and sets the calculated target IVC for the variable valve mechanism 24. In other words, the amount of air taken into the cylinder can be decreased by advancing or retarding the target IVC. This makes it possible to reduce the torque to be generated during the immediately following explosion stroke. Thus, the target torque decreased at time t44 can be achieved.

### Details of Process Performed by Fourth Embodiment

FIG. 15 is a flowchart illustrating a routine that the ECU 60 executes in accordance with the fourth embodiment. The routine starts at timings indicated, for instance, by arrows A and H in FIG. 14.

The routine shown in FIG. 15 performs step 130 to calculate the target throttle angle in accordance with the target torque entered in step 100 and calculate the target IVO in accordance with the engine's operating status (NE, KL, etc.). In step 130, the target IVC is not calculated. Subsequently, the routine performs step 104 to exercise throttle control.

Next, the routine performs step 132 to judge whether the current time represents the timing of IVC calculation. For example, time t45, which is indicated by the arrow H in FIG. 14, represents the timing of IVC calculation. If the judgment result obtained in step 132 does not indicate that the current time represents the timing of IVC calculation, the routine terminates.

If, on the other hand, the judgment result obtained in step 132 indicates that the current time represents the timing of IVC calculation, the routine performs step 134 to acquire the latest target torque and estimated torque. Next, the routine performs step 136 to determine the difference between the target torque and estimated torque, which were acquired in step 134, and calculate the target IVC in accordance with the difference. Subsequently, the routine performs step 138 to exercise intake valve closing control. In step 138, the target IVC calculated in step 136 is set for the variable valve mechanism 24. Upon completion of step 138, the routine terminates.

As described above, after the target throttle angle is calculated at time t41, which precedes an exhaust stroke, the fourth embodiment calculates the target IVC at time t45 during an intake stroke. The target IVC is calculated in consideration of the latest target torque and estimated torque prevailing during the intake stroke. Therefore, even if the target torque is changed due, for instance, to disturbance after target throttle angle calculation at time t41, the target IVC can be calculated later to accurately achieve the changed target torque.

In addition, even if the target torque is decreased after the throttle valve 32 is opened, the fourth embodiment can accurately achieve the target torque.

In the fourth embodiment, the ECU 60 corresponds to the “torque estimation means” according to the first aspect of the present invention; the throttle valve 32 and throttle motor 34 correspond to the “first adjustment means” according to the first aspect of the present invention; and the intake valve 22 and variable valve mechanism 24 correspond to the “second adjustment means” according to the first aspect of the present invention.

Further, in the fourth embodiment, the “target torque acquisition means” according to the first aspect of the present invention is implemented when the ECU 60 performs steps 100 and 134; and the “controlled variable setup means” according to the first aspect of the present invention is implemented when the ECU 60 performs steps 130, 104, 136, and 138.

### Fifth Embodiment

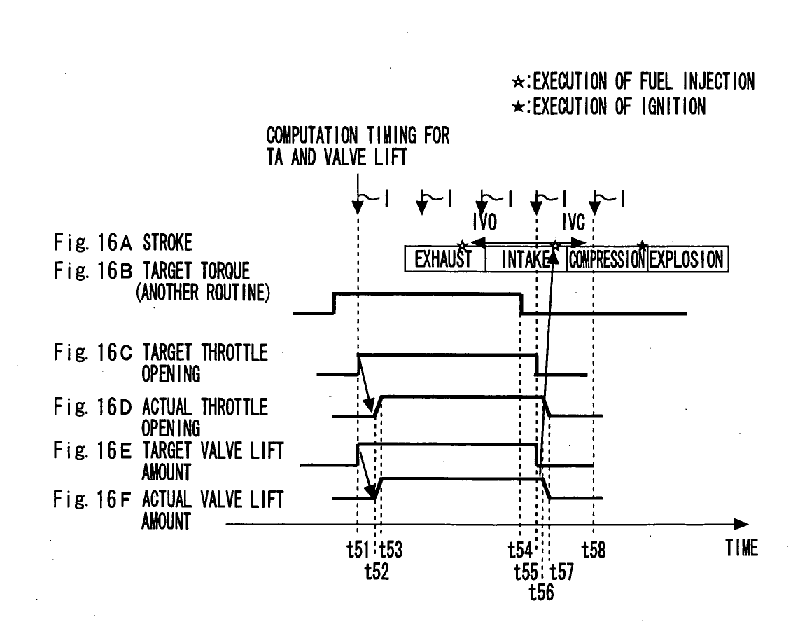

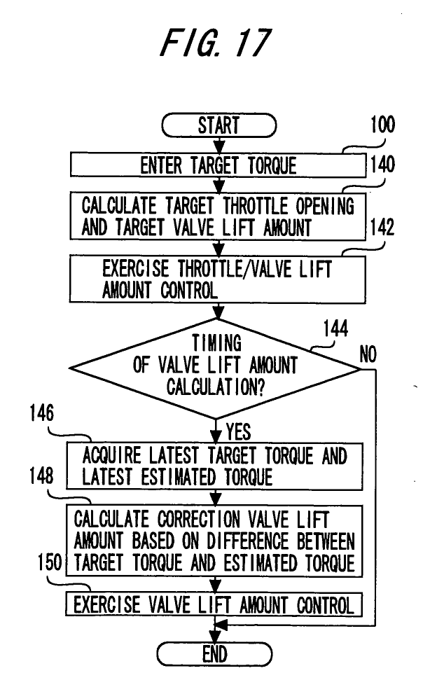

A fifth embodiment of the present invention will now be described with reference to FIGS. 16 and 17. The system according to the fifth embodiment is implemented when the hardware configuration shown in FIG. 1 is employed to let the ECU 60 execute a later-described routine shown in FIG. 17.

### Features of Fifth Embodiment

The fourth embodiment, which has been described earlier, calculates the target IVC, which has a relatively high torque response, after calculating the target throttle angle.

After the intake air has passed through the throttle valve 32, however, the fourth embodiment cannot increase the amount of air taken into the cylinder although it can decrease it. Therefore, the fourth embodiment cannot cope with a sudden increase in the target torque although it can cope with a sudden decrease in the target torque.

Given this factor, the fifth embodiment will now be described with reference to torque base control that makes it possible to cope with a sudden increase in the target torque. More specifically, the fifth embodiment uses a target valve lift amount of the intake valve 22 as an element having a relatively high torque response. The amount of air taken into the cylinder can be increased or decreased by increasing or decreasing the target valve lift amount. Therefore, the torque to be generated during an explosion stroke can be increased or decreased.

A case where a decreased target torque is achieved will now be described with reference to FIGS. 16 and 17.

FIG. 16 is a timing diagram illustrating how the fifth embodiment exercises torque base control. More specifically, this figure shows strokes in FIG. 16(A), target torque changes in FIG. 16(B), target throttle angle changes in FIG. 16(C), actual throttle angle changes in FIG. 16(D), and target valve lift amount changes in FIG. 16(E), and actual valve lift amount changes in FIG. 16(F). Arrows I in the figure indicate the calculation timing for the throttle angle and valve lift amount.

At time t51, which precedes an exhaust stroke, the target throttle angle is calculated in accordance with the target torque to set the calculated target throttle angle for the throttle motor 34 as shown in FIG. 16(C). At time t51, the target valve lift amount is calculated in accordance with the engine's operating status (NE and KL) to set the calculated target valve lift amount for the variable valve mechanism 24 as shown in FIG. 16(E).

Subsequently, the throttle motor 34 is driven between time t52 and time t53 to exercise control so that the actual throttle angle agrees with the target throttle angle calculated at time t51 as shown in FIG. 16(D). The variable valve mechanism 24 is also driven between time t52 and time t53 to exercise control so that an actual valve lift amount agrees with the target valve lift amount calculated at time t51 as shown in FIG. 16(F).

As shown in FIG. 16(B), the target torque is decreased afterward at time t54 during an intake stroke. Then, at time t55, the target throttle angle is calculated to suggest a small throttle angle as shown in FIG. 16(C). In addition, the target valve lift amount is changed to a small valve lift amount as shown in FIG. 16(E). In other words, a correction valve lift amount is calculated in accordance with the difference between the latest target torque and estimated torque prevailing at time t55. The calculated correction valve lift amount is then set for the variable valve mechanism 24.

Throttle angle control is then exercised between time t56 and time t57 so that the actual throttle angle agrees with the target throttle angle calculated at time t55 as shown in FIG. 16(D).

Meanwhile, as the intake air has already passed through the throttle valve 32, the change applied to the actual throttle angle between time t56 and time t57 does not affect the torque to be generated during the immediately following explosion stroke. Therefore, the target torque decreased at time t54 cannot be achieved.

However, the fifth embodiment drives the variable valve mechanism 24 between time t56 and time t57 during an intake stroke to exercise control so that the actual valve lift amount agrees with the correction valve lift amount calculated at time t55 as shown in FIG. 16(F). The intake valve 22 is controlled so as to implement the correction valve lift amount from time t57 until time t58 (IVC). This makes it possible to reduce the amount of air taken into the cylinder. Therefore, the target torque decreased at time t54 can be achieved.

### Details of Process Performed by Fifth Embodiment

FIG. 17 is a flowchart illustrating a routine that the ECU 60 executes in accordance with the fifth embodiment. The routine starts at timings indicated, for instance, by the arrows I in FIG. 16.

The routine shown in FIG. 17 performs step 140 to calculate the target throttle angle in accordance with the target torque entered in step 100 and calculate the target valve lift amount of the intake valve 22 in accordance with the engine's operating status (NE, KL, etc.). Next, the routine performs step 142 to exercise throttle control and valve lift amount control. In step 142, the routine sets the target throttle angle, which was calculated in step 140, for the throttle motor 34, and sets the target valve lift amount, which was also calculated in step 140, for the variable valve mechanism 24.

Next, the routine performs step 144 to judge whether the current time represents the timing of valve lift amount calculation. For example, time t55, which is indicated by arrow I in FIG. 16, represents the timing of valve lift amount calculation. If the judgment result obtained in step 144 does not indicate that the current time represents the timing of valve lift amount calculation, the routine terminates.

If, on the other hand, the judgment result obtained in step 144 indicates that the current time represents the timing of valve lift amount calculation, the routine performs step 146 to acquire the latest target torque and estimated torque. Next, the routine performs step 148 to determine the difference between the target torque and estimated torque, which were acquired in step 146, and calculate the correction valve lift amount (the correction value for the target valve lift amount) in accordance with the determined difference. The routine then performs step 150 to exercise valve lift amount control. In step 150, the correction valve lift amount calculated in step 148 is set for the variable valve mechanism 24. Upon completion of step 150, the routine terminates.

As described above, after the target throttle angle is calculated at time t51, which precedes an exhaust stroke, the fifth embodiment calculates the correction valve lift amount at time t55 during an intake stroke. The correction valve lift amount is calculated in consideration of the latest target torque and estimated torque prevailing during the intake stroke. Therefore, even if the target torque is changed due, for instance, to disturbance after target throttle angle calculation at time t51, the correction valve lift amount can be calculated later to accurately achieve the changed target torque.

In addition, even if the target torque is decreased after the throttle valve 32 is opened, the fifth embodiment can accurately achieve the target torque.

Although the fifth embodiment calculates and sets the correction valve lift amount at time t55 during an intake stroke, the calculation can be performed until the timing of intake valve closing (IVC) is reached.

In the fifth embodiment, the ECU 60 corresponds to the “torque estimation means” according to the first aspect of the present invention; the throttle valve 32 and throttle motor 34 correspond to the “first adjustment means” according to the first aspect of the present invention; and the intake valve 22 and variable valve mechanism 24 correspond to the “second adjustment means” according to the first aspect of the present invention.

Further, in the fifth embodiment, the “target torque acquisition means” according to the first aspect of the present invention is implemented when the ECU 60 performs steps 100 and 146; and the “controlled variable setup means” according to the first aspect of the present invention is implemented when the ECU 60 performs steps 140, 142, 148, and 150.

### Sixth Embodiment

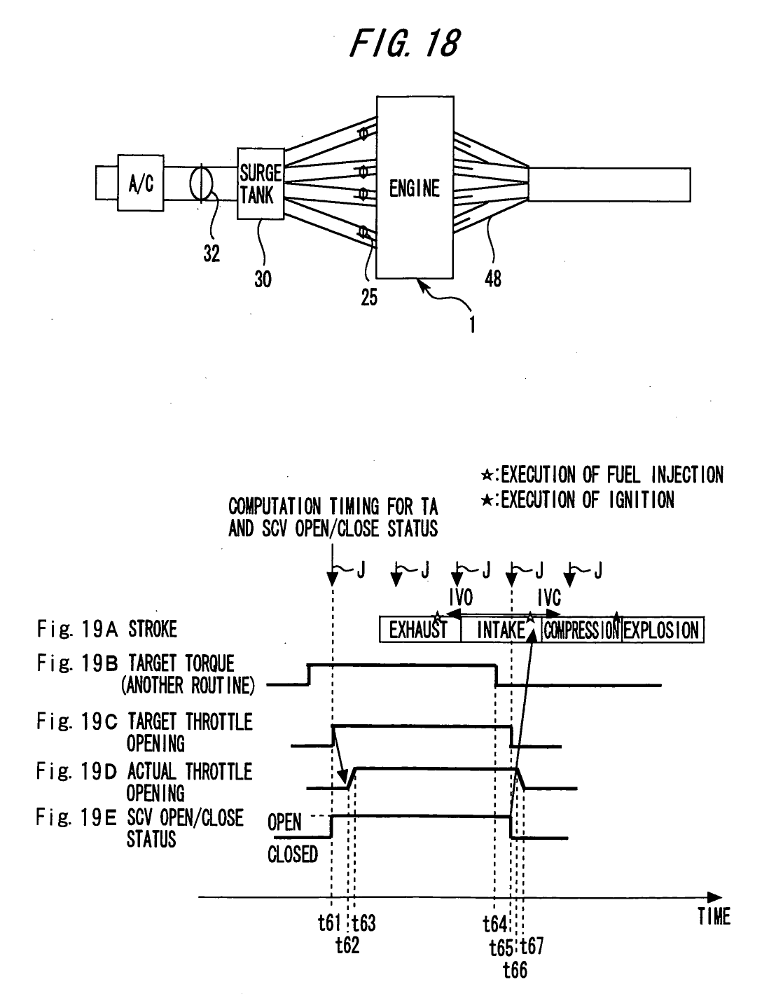

A sixth embodiment of the present invention will now be described with reference to FIGS. 18 to 20. FIG. 18 shows swirl control valves 25, which are installed in the intake path 28 shown in FIG. 1 in accordance with the sixth embodiment. As shown in FIG. 18, the swirl control valve (hereinafter referred to as the “SCV”) 25 is installed in one of two branches of the intake path 28. The SCV 25 is connected to the ECU 60 shown in FIG. 1.

### Features of Sixth Embodiment

The fourth embodiment, which has been described earlier, uses the target IVC as a controlled variable having a relatively high torque response.

The sixth embodiment will be described with reference to a situation where opening/closing of the SCV 25 is used instead of the target IVC as a controlled variable having a relatively high torque response. Even after the intake air has passed through the throttle valve 32, the amount of air taken into the cylinder can be decreased by closing the SCV 25. This makes it possible to reduce the torque to be generated during an explosion stroke.

The sixth embodiment exercises torque base control as depicted in FIG. 19. FIG. 19 is a timing diagram illustrating how the sixth embodiment exercises torque base control. More specifically, this figure shows strokes in FIG. 19(A), target torque changes in FIG. 19(B), target throttle angle changes in FIG. 19(C), actual throttle angle changes in FIG. 19(D), and opening/closing of the SCV 25 in FIG. 19(E). Arrows J in the figure indicate the calculation timing for determining the throttle angle and determining whether or not to open/close the SCV 25 (hereinafter referred to as the “SCV open/close status”).

At time t61, which precedes an exhaust stroke, the target throttle angle is calculated in accordance with the target torque to set the calculated target throttle angle for the throttle motor 34 as shown in FIG. 19(C). At the same time, the SCV open/close status is calculated in accordance with the engine status (NE, KL, etc.) to open the SCV 25 as shown in FIG. 19(E).

Subsequently, the throttle motor 34 is driven between time t62 and time t63 to exercise control so that the actual throttle angle agrees with the target throttle angle calculated at time t61 as shown in FIG. 19(D).

As shown in FIG. 19(B), the target torque is decreased afterward at time t64 during an intake stroke. Then, at time t65, the target throttle angle is calculated to suggest a small throttle angle (for an adjustment in the closing direction) as shown in FIG. 19(C). In addition, the SCV open/close status is calculated to close the SCV 25 as shown in FIG. 19(E).

Throttle angle control is then exercised between time t66 and time t67 so that the actual throttle angle agrees with the target throttle angle calculated at time t65 as shown in FIG. 19(D). More specifically, the actual throttle angle is reduced (for an adjustment in the closing direction).

Meanwhile, as the intake air has already passed through the throttle valve 32, the change applied to the actual throttle angle between time t66 and time t67 does not affect the torque to be generated during the immediately following explosion stroke. Therefore, the target torque decreased at time t64 cannot be achieved.

However, the sixth embodiment closes the SCV 25, as shown in FIG. 19(E), at time t65 after the change in the target torque. This makes it possible to reduce the amount of air taken into the cylinder. Therefore, the target torque decreased at time t64 can be achieved.

### Details of Process Performed by Sixth Embodiment

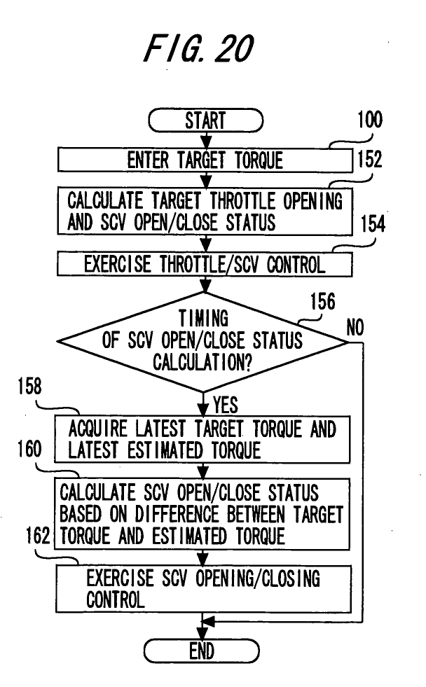

FIG. 20 is a flowchart illustrating a routine that the ECU 60 executes in accordance with the sixth embodiment. The routine starts at timings indicated, for instance, by the arrows I in FIG. 19.

The routine shown in FIG. 20 performs step 152 to calculate the target throttle angle in accordance with the target torque entered in step 100 and calculate the SCV open/close status in accordance with the engine's status (NE, KL, etc.). Next, the routine performs step 154 to exercise throttle control and SCV opening/closing control. In step 154, the routine sets the target throttle angle, which was calculated in step 152, for the throttle motor 34, and opens/closes the SCV 25 in accordance with the calculated SCV open/close status.

Next, the routine performs step 156 to judge whether the current time represents the timing of SCV open/close status calculation. Time t65, which is indicated by arrow J in FIG. 19, represents the timing of SCV open/close status calculation. If the judgment result obtained in step 156 does not indicate that the current time represents the timing of SCV open/close status calculation, the routine terminates.

If, on the other hand, the judgment result obtained in step 156 indicates that the current time represents the timing of SCV open/close status calculation, the routine performs step 158 to acquire the latest target torque and estimated torque. Next, the routine performs step 160 to determine the difference between the target torque and estimated torque, which were acquired in step 158, and calculate the SCV open/close status in accordance with the determined difference. The routine then performs step 162 to exercise SCV opening/closing control in the same manner as in step 154.

As described above, after the target throttle angle is calculated at time t61, which precedes an exhaust stroke, the sixth embodiment operates the SCV 25 at time t65 during an intake stroke. The SCV open/close status is calculated in consideration of the latest target torque and estimated torque prevailing during the intake stroke. Therefore, even if the target throttle angle is changed due, for instance, to disturbance after target throttle angle calculation at time t61, the SCV 25 can be operated later to accurately achieve the changed target torque.

In addition, even if the target torque is decreased after the throttle valve 32 is opened, the sixth embodiment can accurately achieve the target torque.

The sixth embodiment closes the SCV 25 to reduce the amount of air taken into the cylinder for the purpose of coping with a sudden decrease in the target torque. However, similar control can be exercised by using a tumble valve or intake flow valve instead of the SCV 25 to provide the same advantages as the sixth embodiment.

Although the sixth embodiment operates the SCV 25 at time t65 during an intake stroke, the operation can be performed until the timing of IVC is reached. An increased effect can be produced by operating the SCV 25 before IVO.

In the sixth embodiment and its modifications, the ECU 60 corresponds to the “torque estimation means” according to the first aspect of the present invention; the throttle valve 32 and throttle motor 34 correspond to the “first adjustment means” according to the first aspect of the present invention; and the SCV 25, tumble valve, or intake flow valve corresponds to the “second adjustment means” according to the first aspect of the present invention.

Further, in the sixth embodiment and its modifications, the “target torque acquisition means” according to the first aspect of the present invention is implemented when the ECU 60 performs steps 100 and 158; and the “controlled variable setup means” according to the first aspect of the present invention is implemented when the ECU 60 performs steps 152, 154, 160, and 162.

### Seventh Embodiment

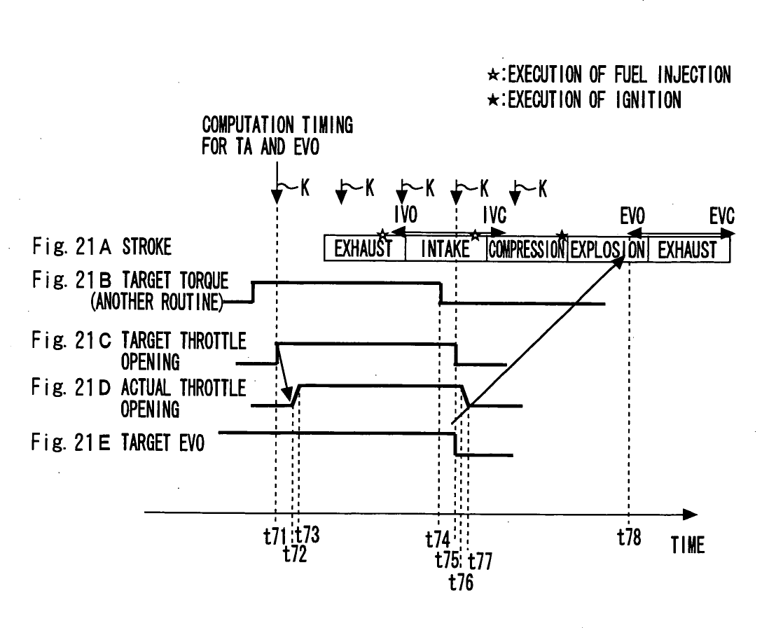

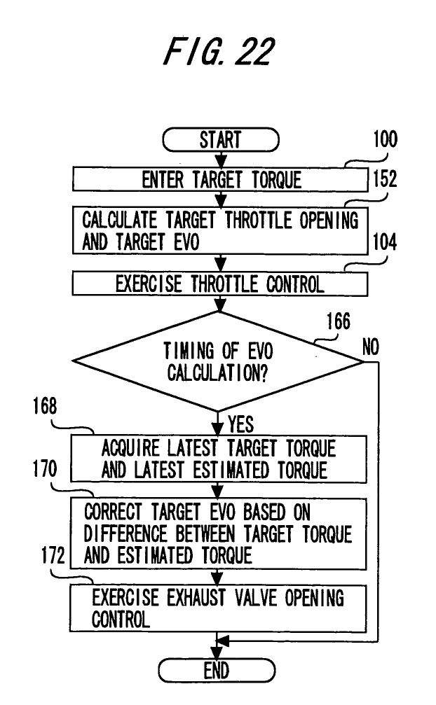

A seventh embodiment of the present invention will now be described with reference to FIGS. 21 and 22. The system according to the seventh embodiment is implemented when the hardware configuration shown in FIG. 1 is employed to let the ECU 60 execute a later-described routine shown in FIG. 22.

### Features of Seventh Embodiment

The fourth embodiment, which has been described earlier, uses the target IVC as a controlled variable having a relatively high torque response. The amount of air taken into the cylinder can be decreased by advancing or retarding the target IVC. This makes it possible to reduce the target torque.

After the intake valve is closed, however, the amount of air taken into the cylinder cannot be changed.

Given this factor, the seventh embodiment will be described with reference to a situation where a target opening timing of the exhaust valve 44 (hereinafter referred to as the “target EVO”) is used instead of the target IVC as a controlled variable having a relatively high torque response. Even after the intake air has passed through the throttle valve 32, the energy generated during an explosion stroke is released as heat before it changes to torque by advancing an exhaust valve opening timing (hereinafter referred to as the “EVO”). This makes it possible to reduce the torque generated during an explosion stroke without changing the amount of air taken into the cylinder. Therefore, even when the target torque is decreased after IVC, the target torque can be accurately achieved.

The seventh embodiment exercises torque base control as depicted in FIG. 21. FIG. 21 is a timing diagram illustrating how the seventh embodiment exercises torque base control. More specifically, this figure shows strokes in FIG. 21(A), target torque changes in FIG. 21(B), target throttle angle changes in FIG. 21(C), actual throttle angle changes in FIG. 21(D), and target opening timing of the exhaust valve 44 (hereinafter referred to as the “target EVO”) in FIG. 21(E). Arrows K in the figure indicate the calculation timing for the throttle angle and target EVO.

At time t71, the target throttle angle is calculated in accordance with the target torque to set the calculated target throttle angle for the throttle motor 34 as shown in FIG. 21(C). At the same time, the target EVO is calculated in accordance with the engine status to set the calculated target EVO for the variable valve mechanism 46 as shown in FIG. 21(E).

Subsequently, the throttle motor 34 is driven between time t72 and time t73 to exercise control so that the actual throttle angle agrees with the target throttle angle calculated at time t71 as shown in FIG. 21(D).

As shown in FIG. 21(B), the target torque is decreased afterward at time t74. Then, at time t75, the target EVO is corrected to set the corrected target EVO for the variable valve mechanism 46 as shown in FIG. 21(E). More specifically, the target EVO is corrected by advancing it in accordance with the difference between the latest target torque and estimated torque prevailing at time t75.

At time t75, the target throttle angle is calculated to suggest a small throttle angle as shown in FIG. 21(C) simultaneously with the target EVO correction. Throttle angle control is then exercised between time t76 and time t77 so that the actual throttle angle agrees with the target throttle angle calculated at time t75 as shown in FIG. 21(D).

Subsequently, at time t78, which represents the target EVO corrected at time t75 during an explosion stroke, the exhaust valve 44 opens.

Meanwhile, as the intake air has already passed through the throttle valve 32, the change applied to the actual throttle angle between time t76 and time t77 does not affect the torque to be generated during the immediately following explosion stroke. Therefore, the target torque decreased at time t74 cannot be achieved.

However, the seventh embodiment corrects the target EVO, as shown in FIG. 21(E), at time t75 after the change in the target torque. More specifically, the target EVO is corrected by advancing it. This raises the ratio at which the energy generated during an explosion stroke is released as heat. Therefore, the torque to be generated during the explosion stroke can be reduced. Consequently, the target torque decreased at time t74 can be achieved.

### Details of Process Performed by Seventh Embodiment

FIG. 22 is a flowchart illustrating a routine that the ECU 60 executes in accordance with the seventh embodiment. The routine starts at timings indicated, for instance, by the arrows K in FIG. 21.

The routine shown in FIG. 22 performs step 164 to calculate the target throttle angle in accordance with the target torque entered in step 100 and calculate the target EVO in accordance with the engine's status (NE, KL, etc.). Next, the routine performs step 104 to exercise throttle control.

Next, the routine performs step 166 to judge whether the current time represents the timing of EVO calculation. Time t75, which is indicated by arrow K in FIG. 21, represents the timing of EVO calculation. If the judgment result obtained in step 166 does not indicate that the current time represents the timing of EVO calculation, the routine terminates.

If, on the other hand, the judgment result obtained in step 166 indicates that the current time represents the timing of EVO calculation, the routine performs step 168 to acquire the latest target torque and estimated torque. Next, the routine performs step 170 to determine the difference between the target torque and estimated torque, which were acquired in step 168, and correct the target EVO in accordance with the determined difference. The routine then performs step 172 to exercise exhaust valve opening control. In step 172, the target EVO, which was corrected in step 170, is set for the variable valve mechanism 46. Upon completion of step 172, the routine terminates.

As described above, after the target throttle angle is calculated at time t71, which precedes an exhaust stroke, the seventh embodiment corrects the target EVO at time t75 during an intake stroke. The corrected target EVO is calculated in consideration of the latest target torque and estimated torque prevailing during the intake stroke. Therefore, even if the target torque is changed due, for instance, to disturbance after target throttle angle calculation at time t51, the target EVO can be calculated later to accurately achieve the changed target torque.

In addition, even if the target torque is decreased after the throttle valve 32 is opened, the seventh embodiment can accurately achieve the target torque.

In the seventh embodiment, the ECU 60 corresponds to the “torque estimation means” according to the first aspect of the present invention; the throttle valve 32 and throttle motor 34 correspond to the “first adjustment means” according to the first aspect of the present invention; and the exhaust valve 44 and variable valve mechanism 46 correspond to the “second adjustment means” according to the first aspect of the present invention.

Further, in the seventh embodiment, the “target torque acquisition means” according to the first aspect of the present invention is implemented when the ECU 60 performs steps 100 and 168; and the “controlled variable setup means” according to the first aspect of the present invention is implemented when the ECU 60 performs steps 164, 104, 170, and 172.

### Eighth Embodiment

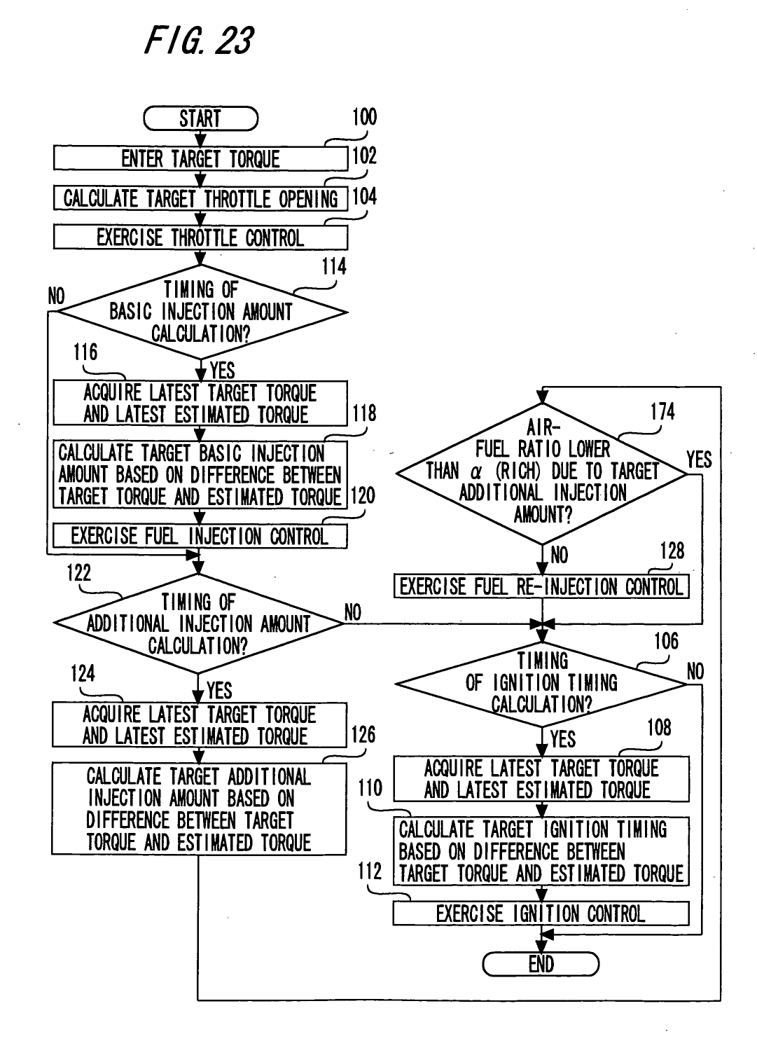

An eighth embodiment of the present invention will now be described with reference to FIG. 23.

The system according to the eighth embodiment is implemented when the hardware configuration shown in FIG. 1 is employed to let the ECU 60 execute a later-described routine shown in FIG. 23.

### Features of Eighth Embodiment

The second embodiment, which has been described earlier, calculates the target injection amounts (target basic injection amount and target additional injection amount), which have a relatively high torque response, after calculating the target throttle angle, which has a relatively low torque response.

However, the air-fuel ratio may become lower than a predetermined value (e.g., 12 to 13) due to the calculated target injection amounts, or more specifically, the air-fuel ratio may become considerably rich due to the target additional injection amount. In such an instance, the emission characteristics may deteriorate.

Given this factor, the eighth embodiment will be described with reference to a situation where the deterioration of emission characteristics is preferentially prevented. More specifically, when the air-fuel ratio becomes lower than the predetermined value due to the calculated target additional injection amount, the eighth embodiment exercises ignition control to achieve the target torque without exercising fuel re-injection control.

### Details of Process Performed by Eighth Embodiment

FIG. 23 is a flowchart illustrating a routine that the ECU 60 executes in accordance with the eighth embodiment.

The routine shown in FIG. 23 performs steps 100 to 126 in the same manner as the routine shown in FIG. 8. More specifically, the routine performs the processing steps up to the step of calculating the target additional injection amount in accordance with the difference between the latest target torque and estimated torque acquired at the timing of additional injection amount calculation.

Next, the routine performs step 174 to judge whether the air-fuel ratio becomes lower than the predetermined value α due to the target additional injection amount calculated in step 126. The predetermined value α is a reference value for judging whether the air-fuel ratio is considerably richer than the stoichiometric air-fuel ratio and typically between 12 and 13.

If the judgment result obtained in step 174 indicates that the air-fuel ratio becomes lower than the predetermined value α, that is, the air-fuel ratio becomes considerably rich, it is concluded that the emission characteristics may deteriorate due to fuel re-injection control. In such an instance, the routine proceeds to step 106 without exercising fuel re-injection control in accordance with the target additional injection amount.

If, on the other hand, the judgment result obtained in step 174 indicates that the air-fuel ratio becomes equal to or higher than the predetermined value α, it is concluded that the emission characteristics do not deteriorate due to fuel re-injection control. In such an instance, the routine performs step 128 to exercise fuel re-injection control. In step 128, the target additional injection amount calculated in step 126 is set for the port injector 26.

Next, the routine performs step 106 in the same manner as the routine shown in FIG. 4 to judge whether the current time represents the timing of ignition timing calculation. If the judgment result obtained in step 106 does not indicate that the current time represents the timing of ignition timing calculation, the routine terminates.

If, on the other hand, the current time represents the timing of ignition timing calculation, the routine performs step 108 to acquire the latest target torque and estimated torque. Next, the routine performs step 110 to determine the difference between the target torque and estimated torque, which were acquired in step 108, and calculate the target ignition timing in accordance with the difference. Subsequently, the routine performs step 112 to exercise ignition control. In step 112, the target ignition timing calculated in step 110 is set for the ignition plug 18. Upon completion of step 112, the routine terminates.

As described above, the eighth embodiment refrains from exercising fuel re-injection control when the air-fuel ratio becomes smaller than the predetermined value α due to the target additional injection amount. In such an instance, the eighth embodiment exercises ignition control to achieve the target torque. This makes it possible to accurately achieve the target torque while preventing the deterioration of emission characteristics.

Meanwhile, the eighth embodiment calculates the target basic injection amount and target additional injection amount without considering the operation mode (stoichiometric or lean operation mode). However, such calculations may be performed while considering the operation mode as described in conjunction with the third embodiment, which has been described earlier.

Further, the eighth embodiment has been described on the assumption that the system having the port injector 26 (FIG. 1) is used. However, the system having the in-cylinder injector 16 (see FIGS. 9 and 10) may also be used as is the case with the second embodiment, which has been described earlier. The use of the in-cylinder injector 16 makes it possible to exercise fuel injection control and fuel re-injection control until immediately before ignition timing.

In the eighth embodiment, the port injector 26 corresponds to the “fuel injection means” according to the eighth aspect of the present invention; and the ignition plug 18 corresponds to the “ignition means” according to the eighth aspect of the present invention.

Further, in the eighth embodiment, the “controlled variable setup means” according to the eighth aspect of the present invention is implemented when the ECU 60 performs steps 174 and 110.

### Ninth Embodiment

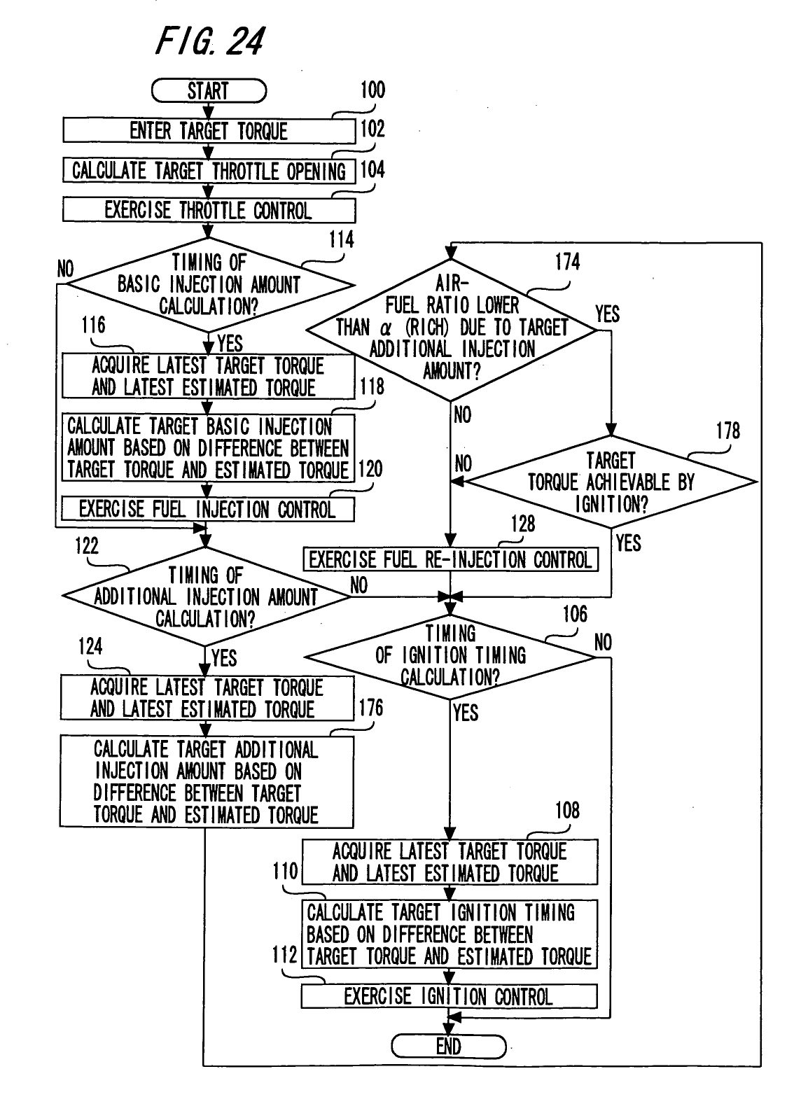

A ninth embodiment of the present invention will now be described with reference to FIG. 24.

The system according to the ninth embodiment is implemented when the hardware configuration shown in FIG. 1 is employed to let the ECU 60 execute a later-described routine shown in FIG. 24.

### Features of Ninth Embodiment

When the air-fuel ratio becomes considerably rich due to the target additional injection amount, the eighth embodiment prevents the deterioration of emission characteristics by giving priority to ignition timing control over fuel re-injection control.

In some cases, however, ignition timing control may not cope with a change in the target torque from the viewpoint of absolute torque, OT, or knocking. For example, if the ignition timing is advanced, knocking is likely to occur. It means that an advance limit is imposed on the ignition timing. If, on the other hand, the ignition timing is retarded, the temperature of the catalyst rises. It means that a retard limit is imposed on the ignition timing.

Given this factor, even when the air-fuel ratio becomes considerably rich due to the target additional injection amount, the ninth embodiment exercises fuel re-injection control as far as the target torque is unachievable by ignition control. This makes it possible to accurately achieve the target torque while protecting the catalyst 50.

### Details of Process Performed by Ninth Embodiment

FIG. 24 is a flowchart illustrating a routine that the ECU 60 executes in accordance with the ninth embodiment.

The routine shown in FIG. 24 performs steps 100 to 124 in the same manner as the routine shown in FIG. 8. More specifically, the routine performs processing steps up to the step of acquiring the target torque and estimate torque at the timing of additional injection amount calculation.

Next, the routine performs step 176 to determine the difference between the latest target torque and estimated torque, which were acquired in step 124, and calculate the target additional injection amount and target ignition timing in accordance with the difference. Step 176 differs from step 126 of the routine shown in FIG. 23 in that the former calculates not only the target additional injection amount but also the target ignition timing. The calculated target ignition timing is used in step 178, which will be described later.

Next, the routine performs step 174 in the same manner as the routine shown in FIG. 23 to judge whether the air-fuel ratio becomes lower than the predetermined value α due to the target additional injection amount. If the judgment result obtained in step 174 indicates that the air-fuel ratio becomes equal to or higher than the predetermined value α, that is, if it is judged that the emission characteristics do not deteriorate, the routine performs step 128 to exercise fuel re-injection control in accordance with the target additional injection amount.

If, on the other hand, the judgment result obtained in step 174 indicates that the air-fuel ratio becomes lower than the predetermined value α, that is, if it is judged that the emission characteristics deteriorate, the routine performs step 178 to judge whether the target torque can be achieved by ignition. Step 178 judges whether the target ignition timing calculated in step 176 can be achieved from the viewpoint of OT or the like.

If the judgment result obtained in step 178 does not indicate that the target torque can be achieved by ignition, or more specifically, if, for instance, the advance limit or retard limit is exceeded by the target ignition timing, the routine performs step 128 to exercise fuel re-injection control.

If, on the other hand, the judgment result obtained in step 178 indicates that the target torque can be achieved by ignition, the routine proceeds to step 106 without exercising fuel re-injection control in accordance with the target additional injection amount. In this instance, ignition control takes precedence over fuel re-injection control.

Subsequently, the routine performs step 106 in the same manner as the routine shown in FIG. 23 to judge whether the current time represents the timing of ignition timing calculation. If the judgment result obtained in step 106 does not indicate that the current time represents the timing of ignition timing calculation, the routine terminates.

If, on the other hand, the judgment result obtained in step 106 indicates that the current time represents the timing of ignition timing calculation, the routine performs step 108 to acquire the latest target torque and estimated torque. Next, the routine performs step 110 to determine the difference between the acquired target torque and estimated torque and calculate the target ignition timing in accordance with the difference. The routine then performs step 112 to exercise ignition control. Upon completion of step 112, the routine terminates.

As described above, the ninth embodiment refrains from exercising fuel re-injection control when the air-fuel ratio becomes lower than the predetermined value α due to the target additional injection amount and the target torque is achievable by the target ignition timing. In this instance, the ninth embodiment exercises ignition control in accordance with the target ignition timing to accurately achieve the target torque while preventing the deterioration of emission characteristics as is the case with the eighth embodiment, which has been described earlier.

Further, the ninth embodiment exercises fuel re-injection control in accordance with the target additional injection amount when the air-fuel ratio becomes lower than the predetermined value α due to the target additional injection amount and the target torque is unachievable by the target ignition timing. In this instance, the ninth embodiment lets the emission characteristics deteriorate to some degree, but accurately achieves the target torque while protecting the catalyst 50.

Meanwhile, the ninth embodiment calculates the target basic injection amount and target additional injection amount without considering the operation mode (stoichiometric or lean operation mode). However, such calculations may be performed while considering the operation mode as described in conjunction with the third embodiment, which has been described earlier.

Further, the ninth embodiment has been described on the assumption that the system having the port injector 26 (FIG. 1) is used. However, the system having the in-cylinder injector 16 (see FIGS. 9 and 10).may also be used as is the case with the second embodiment, which has been described earlier. The use of the in-cylinder injector 16 makes it possible to exercise fuel injection control and fuel re-injection control until immediately before ignition timing.

In the ninth embodiment, the port injector 26 corresponds to the “fuel injection means” according to the ninth aspect of the present invention; and the ignition plug 18 corresponds to the “ignition means” according to the ninth aspect of the present invention.

Further, in the ninth embodiment, the “judgment means” according to the ninth aspect of the present invention is implemented when the ECU 60 performs step 178; and the “controlled variable setup means” according to the ninth aspect of the present invention is implemented when the ECU 60 performs steps 174, 178, and 128.

### Tenth Embodiment

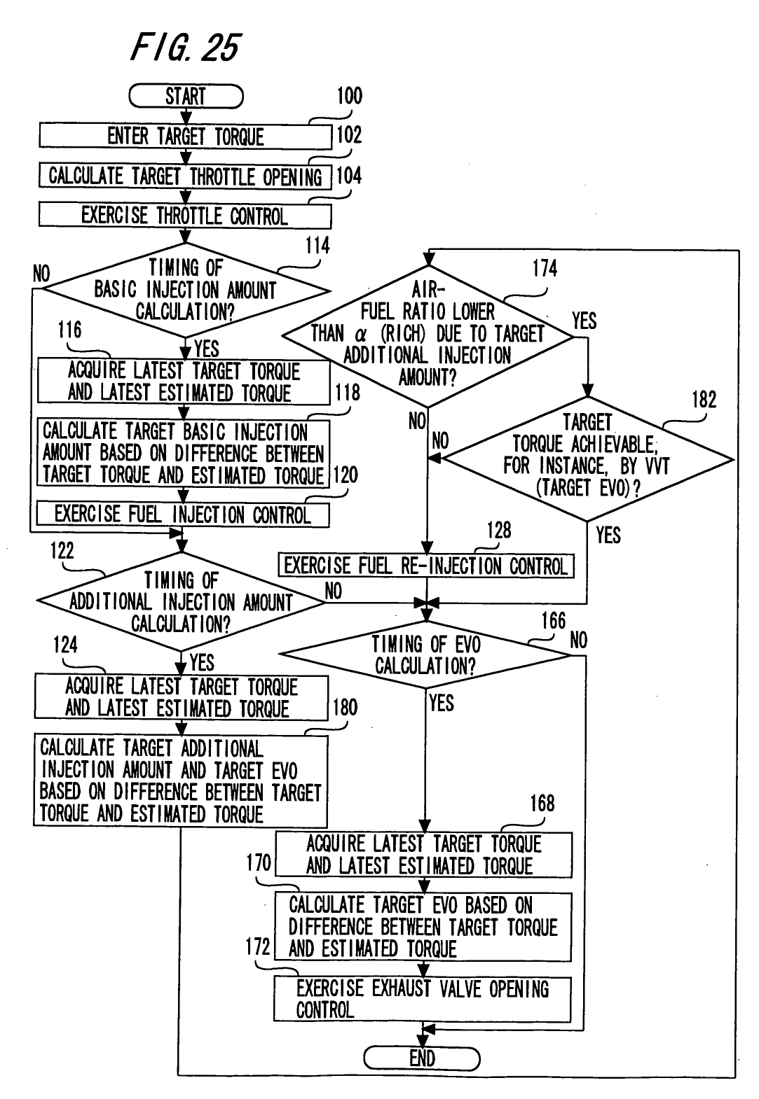

A tenth embodiment of the present invention will now be described with reference to FIG. 25.

The system according to the tenth embodiment is implemented when the hardware configuration shown in FIG. 1 is employed to let the ECU 60 execute a later-described routine shown in FIG. 25.

### Features of Tenth Embodiment

If the target torque is unachievable by ignition, the ninth embodiment exercises fuel re-injection control even when the air-fuel ratio becomes considerably rich due to the target additional injection amount.

The tenth embodiment exercises EVO control instead of ignition control. More specifically, when the air-fuel ratio becomes considerably rich due to the target additional injection amount, the tenth embodiment prevents the deterioration of emission characteristics by giving priority to EVO control over fuel re-injection control.

Meanwhile, when the target torque is suddenly decreased, the target torque can be achieved by exercising EVO control. However, if the target torque is increased, a situation may arise in which the target torque cannot be achieved by the EVO control. This is applicable not only to the EVO control but also to the IVC control.

Given this factor, even when the air-fuel ratio becomes considerably rich due to fuel re-injection control based on the target additional injection amount, the tenth embodiment exercises fuel re-injection control as far as the target torque is unachievable by EVO. This makes it possible to achieve the target torque accurately with certainty.

### Details of Process Performed by Tenth Embodiment

FIG. 25 is a flowchart illustrating a routine that the ECU 60 executes in accordance with the tenth embodiment.

The routine shown in FIG. 25 first performs steps 100 to 124 in the same manner as the routine shown in FIG. 24.

Next, the routine performs step 180 to determine the difference between the latest target torque and estimated torque, which were acquired in step 124, and calculate the target additional injection amount and target EVO in accordance with the difference. Step 180 calculates not only the target additional injection amount but also the target EVO. The calculated target EVO is used in step 182, which will be described later.

Next, the routine performs step 174 in the same manner as the routine shown in FIG. 24 to judge whether the air-fuel ratio becomes lower than the predetermined value α due to the target additional injection amount. If the judgment result obtained in step 174 indicates that the air-fuel ratio becomes equal to or higher than the predetermined value α, that is, if it is judged that the emission characteristics do not deteriorate, the routine performs step 128 to exercise fuel re-injection control in accordance with the target additional injection amount.

If, on the other hand, the judgment result obtained in step 174 indicates that the air-fuel ratio becomes lower than the predetermined value α, the routine performs step 182 to judge whether the target torque can be achieved by the variable valve mechanism (e.g., VVT mechanism) 46. Step 182 judges whether the target torque can be achieved by the target EVO calculated in step 180.

If the judgment result obtained in step 182 does not indicate that the target torque can be achieved by the target EVO, i.e., more specifically, if, for instance, the target torque is suddenly increased, the routine performs step 128 to exercise fuel re-injection control. If, on the other hand, the judgment result obtained in step 182 indicates that the target torque can be achieved by the target EVO, the routine proceeds to step 166 without exercising fuel re-injection control.

Subsequently, the routine performs step 166 in the same manner as the routine shown in FIG. 22 to judge whether the current time represents the timing of EVO calculation. If the judgment result obtained in step 166 does not indicate that the current time represents the timing of EVO calculation, the routine terminates.

If, on the other hand, the judgment result obtained in step 166 indicates that the current time represents the timing of EVO calculation, the routine performs step 168 to acquire the latest target torque and estimated torque. Next, the routine performs step 170 to determine the difference between the target torque and estimated torque and calculate the target EVO in accordance with the difference. The routine then performs step 172 to open the exhaust valve 44 in accordance with the target EVO calculated in step 170. Upon completion of step 172, the routine terminates.

As described above, the tenth embodiment exercises exhaust valve opening control (EVO control) in preference to fuel re-injection control when the air-fuel ratio becomes lower than the predetermined value α due to the target additional injection amount. This makes it possible to accurately achieve the target torque while preventing the deterioration of emission characteristics.

Further, even when the air-fuel ratio becomes lower than the predetermined value α due to the target additional injection amount, the tenth embodiment exercises fuel re-injection control in accordance with the target additional injection amount as far as the target torque is unachievable by the target EVO. In this instance, the tenth embodiment lets the emission characteristics deteriorate to some degree, but achieves the target torque accurately with certainty.

Meanwhile, the tenth embodiment has been described on the assumption that the system having the port injector 26 (FIG. 1) is used. However, the system having the in-cylinder injector 16 (see FIGS. 9 and 10) may also be used as is the case with the second embodiment, which has been described earlier. The use of the in-cylinder injector 16 makes it possible to exercise fuel injection control and fuel re-injection control until immediately before ignition timing.

In the tenth embodiment, the port injector 26 corresponds to the “fuel injection means” according to the tenth and eleventh aspects of the present invention; the exhaust valve 44 corresponds to the “exhaust valve” according to the tenth aspect of the present invention; and the variable valve mechanism 46 corresponds to the “exhaust variable valve mechanism” according to the tenth and eleventh aspects of the present invention.

Further, in the tenth embodiment, the “controlled variable setup means” according to the tenth aspect of the present invention is implemented when the ECU 60 performs steps 174, 170, and 172; the “judgment means” according to the eleventh aspect of the present invention is implemented when the ECU 60 performs step 182; and the “controlled variable setup means” according to the eleventh aspect of the present invention is implemented when the ECU 60 performs steps 174, 182, and 128.

### Eleventh Embodiment

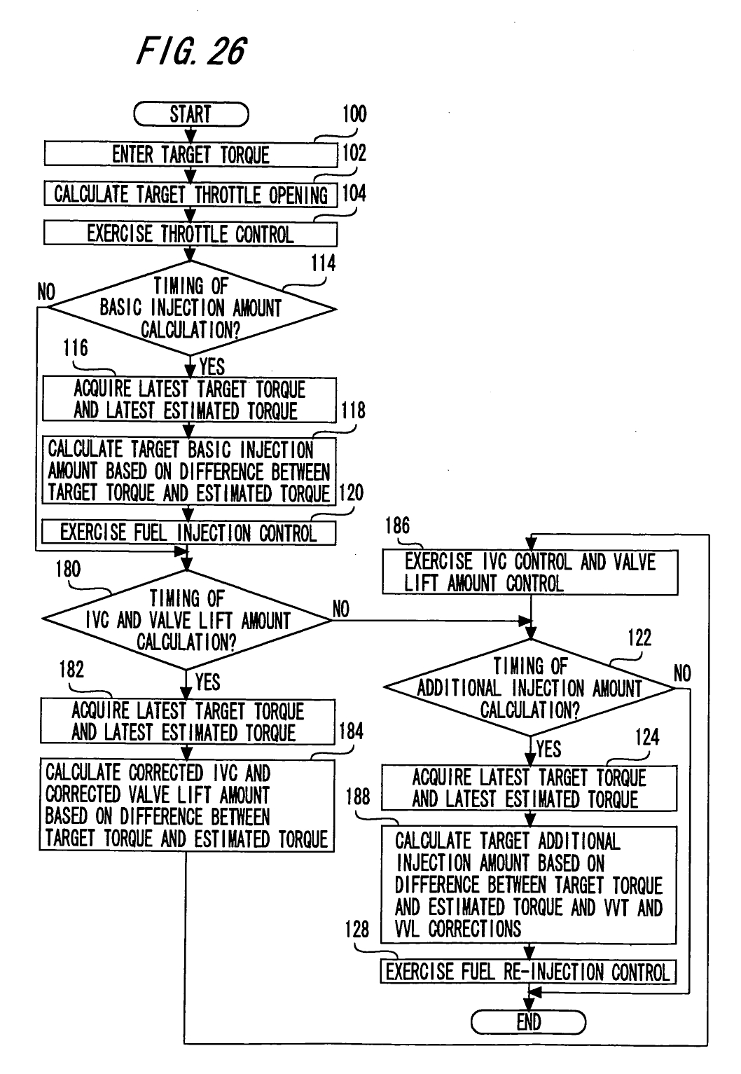

An eleventh embodiment of the present invention will now be described with reference to FIG. 26.

The system according to the eleventh embodiment is implemented when the hardware configuration shown in FIG. 1 is employed to let the ECU 60 execute a later-described routine shown in FIG. 26.

### Features of Eleventh Embodiment

The eighth and ninth embodiments, which have been described earlier, exercise ignition control in preference to fuel re-injection control to prevent the deterioration of emission characteristics.

However, when the target torque is to be achieved by ignition, an increase in the catalyst bed temperature (OT) may occur although satisfactory air-fuel ratio controllability is obtained.

Given this factor, the eleventh embodiment does not achieve the target torque by exercising ignition control, but first calculates the target basic injection amount, then corrects the target IVC and target valve lift amount, and subsequently calculates the target additional injection amount to achieve the target torque.

### Details of Process Performed by Eleventh Embodiment

FIG. 26 is a flowchart illustrating a routine that the ECU 60 executes in accordance with the eleventh embodiment.

The routine shown in FIG. 26 first performs steps 100 to 120 in the same manner as the routine shown in FIG. 24. More specifically, the routine performs processing steps up to the step of exercising fuel injection control.

Next, the routine performs step 180 to judge whether the current time represents the timing of IVC and valve lift amount calculation. The timing of IVC and valve lift amount calculation is set between the timing of basic injection amount calculation and the timing of additional injection amount calculation. If the judgment result obtained in step 180 indicates that the current time represents the timing of IVC and valve lift amount calculation, the routine performs step 182 to acquire the latest target torque and estimated torque.

Next, the routine performs step 184 to determine the difference between the target torque and estimated torque and correct the previously calculated target IVC and target valve lift amount in accordance with the difference. It should be noted that step 184 performs calculations to obtain a corrected IVC and a corrected valve lift amount. More specifically, when the target torque is increased, the corrected valve lift amount is calculated because the increased target torque cannot be achieved by the corrected IVC. When, on the other hand, the target torque is decreased, at least one of the corrected IVC and the corrected valve lift amount is calculated.

Next, the routine performs step 186 to exercise IVC control and valve lift amount control. In step 186, the corrected IVC and corrected valve lift amount, which were calculated as described above, are set for the variable valve mechanism 24.

Next, the routine performs step 122 to judge whether the current time represents the timing of additional injection amount calculation. If the judgment result obtained in step 122 does not indicate that the current time represents the timing of additional injection amount calculation, the routine terminates.

If, on the other hand, the judgment result obtained in step 122 indicates that the current time represents the timing of additional injection amount calculation, the routine performs step 124 to acquire the latest target torque and estimated torque. Next, the routine performs step 188 to determine the difference between the acquired target torque and estimated torque and calculate the target additional injection amount in accordance with the difference and with the corrected IVC and corrected valve lift amount, which were calculated in step 184. Step 188 is performed to estimate the amount of air taken into the cylinder in accordance with the corrected IVC and corrected valve lift amount and calculate the target additional injection amount in consideration of the estimated air amount. Subsequently, the routine performs step 128 to exercise fuel re-injection control in accordance with the target additional injection amount calculated in step 188. More specifically, the calculated target additional injection amount is set for the port injector 26. Upon completion of step 128, the routine terminates.

As described above, the eleventh embodiment calculates the target additional injection amount in consideration of the air amount changed by the corrected IVC and corrected valve lift amount. This makes it possible to accurately achieve a target air-fuel ratio. Therefore, the deterioration of emission characteristics can be prevented as is the case where the target torque is achieved by exercising ignition control. Further, the catalyst 50 can be protected because the target ignition timing is achieved without exercising the ignition control.

Further, the eleventh embodiment calculates not only the corrected IVC but also the corrected valve lift amount. Therefore, even when the target torque is increased, it can be accurately achieved.

Meanwhile, the eleventh embodiment has been described on the assumption that the system having the port injector 26 (FIG. 1) is used. However, the system having the in-cylinder injector 16 (see FIGS. 9 and 10) may also be used as is the case with the second embodiment, which has been described earlier. The use of the in-cylinder injector 16 makes it possible to exercise fuel injection control and fuel re-injection control until immediately before ignition timing.

Further, the eleventh embodiment uses the IVC and valve lift amount as air control means. Alternatively, however, the SCV 25 or the like may be used as the air control means. When SCV opening/closing control is exercised in the same manner as the sixth embodiment, which has been described earlier, the amount of air taken into the cylinder can be reduced to cope with a decrease in the target torque.

Furthermore, a decreased target torque can be achieved by calculating the target basic injection amount and then calculating the EVO in the same manner as the seventh embodiment, which has been described earlier, instead of calculating the corrected IVC, corrected valve lift amount, and target additional injection amount.

In the eleventh embodiment, the ECU 60 corresponds to the “torque estimation means” according to the first aspect of the present invention; the throttle valve 32 and throttle motor 34 correspond to the “first adjustment means” according to the first aspect of the present invention; and the port injector 26 and variable valve mechanism 24 correspond to the “second adjustment means” according to the fourth aspect of the present invention.

Further, in the eleventh embodiment, the “target torque acquisition means” according to the first aspect of the present invention is implemented when the ECU 60 performs steps 100, 182, and 124; the “controlled variable setup means” according to the first aspect of the present invention is implemented when the ECU 60 performs steps 102, 104, 184, and 186; and the “controlled variable setup means” according to the fourth aspect of the present invention is implemented when the ECU 60 performs steps 188 and 128.

### Twelfth Embodiment

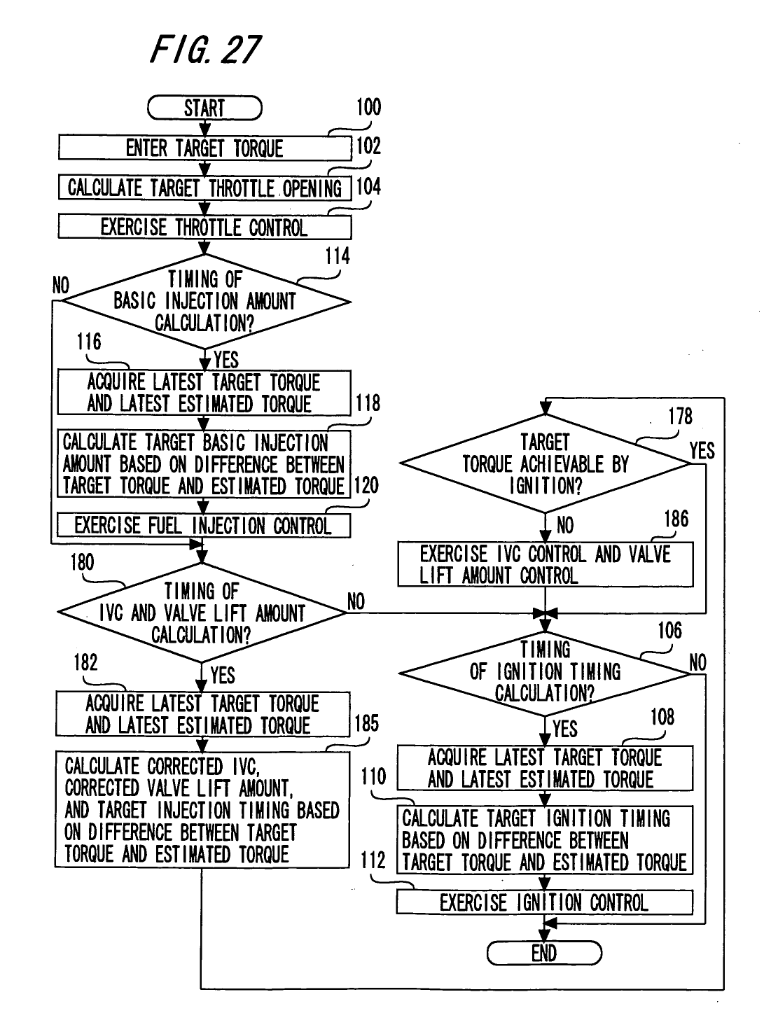

A twelfth embodiment of the present invention will now be described with reference to FIG. 27.

The system according to the twelfth embodiment is implemented when the hardware configuration shown in FIG. 1 is employed to let the ECU 60 execute a later-described routine shown in FIG. 27.

### Features of Twelfth Embodiment

The fourth and fifth embodiments, which have been described earlier, change the amount of air taken into the cylinder by exercising IVC control or valve lift amount control.

However, a change in the amount of air taken into the cylinder may result in decreased air-fuel ratio controllability. From the viewpoint of air-fuel ratio controllability, therefore, it is preferred that ignition control be exercised in preference to air control (IVC/valve lift amount control).

However, when the target torque is to be achieved by ignition, an increase in the catalyst bed temperature (OT) may occur although satisfactory air-fuel ratio controllability is obtained.

Therefore, when the target torque cannot be achieved by ignition in consideration of OT, the twelfth embodiment exercises air control to achieve the target torque. When, on the other hand, the target torque can be achieved by ignition, the twelfth embodiment exercises ignition control in preference to air control.

### Details of Process Performed by Twelfth Embodiment

FIG. 27 is a flowchart illustrating a routine that the ECU 60 executes in accordance with the twelfth embodiment.

The routine shown in FIG. 27 first performs steps 100 to 182 in the same manner as the routine shown in FIG. 26. More specifically, the routine performs processing steps up to the step of acquiring the latest target torque and estimated torque at the timing of IVC/valve lift amount calculation.

Next, the routine performs step 185 to determine the difference between the acquired latest target torque and estimated torque and calculate the corrected IVC, corrected valve lift amount, and target ignition timing in accordance with the difference. Step 185 differs from step 184 of the routine shown in FIG. 26 in that the former calculates not only the corrected IVC and corrected valve lift amount, but also the target ignition timing. The calculated target ignition timing is used in the next step 178.

Next, the routine performs step 178 to judge whether the target torque can be achieved by ignition. Step 178 is performed in consideration of OT or the like to judge whether the above-mentioned target ignition timing can be achieved. If the judgment result obtained in step 178 does not indicate that the target torque can be achieved by ignition, the routine performs step 186 to exercise IVC control in accordance with the corrected IVC calculated in step 185 and exercise valve lift amount control in accordance with the corrected valve lift amount.

If, on the other hand, the judgment result obtained in step 178 indicates that the target torque can be achieved by ignition, the routine proceeds to step 106 without exercising IVC control or valve lift amount control. This ensures that ignition control takes precedence over air control.

Subsequently, the routine performs step 106 to judge whether the current time represents the timing of ignition timing calculation. If the judgment result obtained in step 106 does not indicate that the current time represents the timing of ignition timing calculation, the routine terminates.

If, on the other hand, the judgment result obtained in step 106 indicates that the current time represents the timing of ignition timing calculation, the routine performs step 108 to acquire the latest target torque and estimated torque. Next, the routine performs step 110 to determine the difference between the acquired target torque and estimated torque and calculate the target ignition timing in accordance with the difference. The routine then performs step 112 to exercise ignition control in accordance with the target ignition timing calculated in step 110. Upon completion of step 112, the routine terminates.

As described above, when it is judged that the target torque can be achieved by ignition, the twelfth embodiment refrains from exercising IVC/valve lift amount control. In this instance, the eleventh embodiment exercises ignition control, which exhibits a high air-fuel ratio control capability, to accurately achieve the target torque while preventing the deterioration of emission characteristics.

Further, when it is judged that the target torque cannot be achieved by ignition in consideration of OT or the like, the twelfth embodiment preferentially exercises IVC/valve lift amount control. More specifically, the twelfth embodiment exercises air control to achieve the target torque, thereby protecting the catalyst 50 while letting the emission characteristics deteriorate to some degree.

Meanwhile, the twelfth embodiment uses the IVC and valve lift amount as air control means. Alternatively, however, the SCV 25 or the like may be used as the air control means. When SCV opening/closing control is exercised in the same manner as the sixth embodiment, which has been described earlier, the amount of air taken into the cylinder can be reduced to cope with a decrease in the target torque.

In the twelfth embodiment, the ignition plug 18 corresponds to the “ignition means” according to the twelfth and thirteenth aspects of the present invention; the intake valve 22 corresponds to the “intake valve” according to the twelfth aspect of the present invention; and the variable valve mechanism 24 corresponds to the “intake variable valve mechanism” according to the twelfth and thirteenth aspects of the present invention.

Further, in the twelfth embodiment, the “controlled variable setup means” according to the twelfth aspect of the present invention is implemented when the ECU 60 performs steps 178, 110, and 112; the “judgment means” according to the thirteenth aspect of the present invention is implemented when the ECU 60 performs step 178; and the “controlled variable setup means” according to the thirteenth aspect of the present invention is implemented when the ECU 60 performs steps 185, 178, and 186.

1. An internal combustion engine control device comprising:
target torque acquisition means for acquiring a target torque of an internal combustion engine;
torque estimation means for estimating the torque to be generated by the internal combustion engine;
first adjustment means capable of adjusting the torque to be generated by the internal combustion engine;
second adjustment means capable of adjusting, with a higher response than the first adjustment means, the torque to be generated by the internal combustion engine; and
controlled variable setup means, which sets a controlled variable for the first adjustment means in accordance with a target torque at a first timing, and sets a controlled variable for the second adjustment means in accordance with a target torque at a second timing, which comes after the first timing, and with a torque estimated at the second timing,
wherein the interval between the first timing and the second timing is not longer than one combustion cycle of the internal combustion engine.

2. An internal combustion engine control device comprising:
target torque acquisition means for acquiring a target torque of an internal combustion engine;
first adjustment means capable of adjusting the torque to be generated by the internal combustion engine;
second adjustment means capable of adjusting, with a higher response than the first adjustment means, the torque to be generated by the internal combustion engine; and
controlled variable setup means, which sets a controlled variable for the first adjustment means in accordance with a target torque at a first timing, and sets a controlled variable for the second adjustment means in accordance with a target torque at a second timing, which comes after the first timing,
wherein the interval between the first timing and the second timing is not longer than one combustion cycle of the internal combustion engine.

3. An internal combustion engine control device comprising:
target torque acquisition means for acquiring a target torque of an internal combustion engine;
torque estimation means for estimating the torque to be generated by the internal combustion engine;
first adjustment means capable of adjusting the torque to be generated by the internal combustion engine;
second adjustment means capable of adjusting, with a higher response than the first adjustment means, the torque to be generated by the internal combustion engine; and
controlled variable setup means, which sets a controlled variable for the first adjustment means in accordance with a target torque at a first timing, and sets a controlled variable for the second adjustment means in accordance with a torque estimated at a second timing, which comes after the first timing,
wherein the interval between the first timing and the second timing is not longer than one combustion cycle of the internal combustion engine.

4. The internal combustion engine control device according to claim 1,
wherein the controlled variable setup means further sets a controlled variable for the second adjustment means in accordance with a target torque at a third timing, which comes after the second timing, and with a torque estimated at the third timing, and
wherein the interval between the first timing and the third timing is not longer than one combustion cycle of the internal combustion engine.

5. The internal combustion engine control device according to claim 1,
wherein the controlled variable setup means further sets a controlled variable for the second adjustment means in accordance with a target torque at a third timing, which comes after the second timing, and
wherein the interval between the first timing and the third timing is not longer than one combustion cycle of the internal combustion engine.

6. The internal combustion engine control device according to claim 1,
wherein the controlled variable setup means further sets a controlled variable for the second adjustment means in accordance with a torque estimated at a third timing, which comes after the second timing, and
wherein the interval between the first timing and the third timing is not longer than one combustion cycle of the internal combustion engine.

7. The internal combustion engine control device according to claim 1, the internal combustion engine having a lean-burn capability, further comprising operation mode judgment means for judging an operation mode of the internal combustion engine,
wherein the controlled variable setup means sets a controlled variable for the second adjustment means in consideration of the operation mode.

8. The internal combustion engine control device according to claim 1,
wherein the second adjustment means includes fuel injection means and ignition means, and
wherein the controlled variable setup means preferentially sets a controlled variable for the ignition means at the second or third timing when the air-fuel ratio becomes lower than a predetermined value due to a controlled variable that is set for the fuel injection means at the second or third timing.

9. The internal combustion engine control device according to claim 8,
wherein the controlled variable setup means includes judgment means for judging whether a controlled variable for the second adjustment means is attainable, and when the controlled variable for the ignition means is judged by the judgment means to be unattainable, sets a controlled variable for the fuel injection means at the second or third timing even when the controlled variable for the ignition means is to be preferentially set.

10. The internal combustion engine control device according to claim 1,
wherein the second adjustment means includes fuel injection means and an exhaust variable valve mechanism that is capable of changing the valve opening characteristics of an exhaust valve, and
wherein the controlled variable setup means preferentially sets a controlled variable for the exhaust variable valve mechanism at the second or third timing when the air-fuel ratio becomes lower than a predetermined value due to a controlled variable that is set for the fuel injection means at the second or third timing.

11. The internal combustion engine control device according to claim 10,
wherein the controlled variable setup means includes judgment means for judging whether a controlled variable for the second adjustment means is attainable, and when the controlled variable for the exhaust variable valve mechanism is judged by the judgment means to be unattainable, sets a controlled variable for the fuel injection means at the second or third timing even when the controlled variable for the exhaust variable valve mechanism is to be preferentially set.

12. The internal combustion engine control device according to claim 1,
wherein the second adjustment means includes ignition means and an intake variable valve mechanism that is capable of changing the valve opening characteristics of an intake valve, and
wherein the controlled variable setup means preferentially sets a controlled variable for the ignition means at the second or third timing.

13. The internal combustion engine control device according to claim 12,
wherein the controlled variable setup means includes judgment means for judging whether a controlled variable for the second adjustment means is attainable, and when the controlled variable for the ignition means is judged by the judgment means to be unattainable, sets a controlled variable for the intake variable valve mechanism at the second or third timing even when the controlled variable for the ignition means is to be preferentially set.

14. An internal combustion engine control device comprising:
target torque acquisition unit for acquiring a target torque of an internal combustion engine;
torque estimation unit for estimating the torque to be generated by the internal combustion engine;
first adjustment unit capable of adjusting the torque to be generated by the internal combustion engine;
second adjustment unit capable of adjusting, with a higher response than the first adjustment unit, the torque to be generated by the internal combustion engine; and
controlled variable setup unit, which sets a controlled variable for the first adjustment unit in accordance with a target torque at a first timing, and sets a controlled variable for the second adjustment unit in accordance with a target torque at a second timing, which comes after the first timing, and with a torque estimated at the second timing,
wherein the interval between the first timing and the second timing is not longer than one combustion cycle of the internal combustion engine.

15. An internal combustion engine control device comprising:
target torque acquisition unit for acquiring a target torque of an internal combustion engine;
first adjustment unit capable of adjusting the torque to be generated by the internal combustion engine;
second adjustment unit capable of adjusting, with a higher response than the first adjustment unit, the torque to be generated by the internal combustion engine; and
controlled variable setup unit, which sets a controlled variable for the first adjustment unit in accordance with a target torque at a first timing, and sets a controlled variable for the second adjustment unit in accordance with a target torque at a second timing, which comes after the first timing,
wherein the interval between the first timing and the second timing is not longer than one combustion cycle of the internal combustion engine.

16. An internal combustion engine control device comprising:
target torque acquisition unit for acquiring a target torque of an internal combustion engine;
torque estimation unit for estimating the torque to be generated by the internal combustion engine;
first adjustment unit capable of adjusting the torque to be generated by the internal combustion engine;
second adjustment unit capable of adjusting, with a higher response than the first adjustment unit, the torque to be generated by the internal combustion engine; and
controlled variable setup unit, which sets a controlled variable for the first adjustment unit in accordance with a target torque at a first timing, and sets a controlled variable for the second adjustment unit in accordance with a torque estimated at a second timing, which comes after the first timing,
wherein the interval between the first timing and the second timing is not longer than one combustion cycle of the internal combustion engine.
